(19) United States
(12) Patent Application Publication
(10) Pub. No.: US 2025/0019117 A1
(43) Pub. Date: Jan. 16, 2025

(54) CONTAINTERS, BLANKS FOR CONTAINERS AND METHODS FOR FORMING CONTAINERS AND PACKAGING PRODUCT

(71) Applicant: WestRock Packaging Systems, LLC, Atlanta, GA (US)

(72) Inventors: John VALENCIA, Johns Creek, GA (US); Alyssa J. SCHERER, Duluth, GA (US)

(21) Appl. No.: 18/711,511

(22) PCT Filed: Nov. 18, 2022
(86) PCT No.: PCT/US2022/050399

§ 371 Date: May 17, 2024

Related U.S. Application Data
(60) Provisional application No. 63/281,223, filed on Nov. 19, 2021.

(51) Int. Cl. B65D 5/66; B31B 50/74; B31B 100/00; B31B 110/30; B31B 120/10; B65B 7/26; B65D 5/20

(52) U.S. Cl. CPC B65D 5/6697; B31B 50/74; B65B 7/26; B65D 5/2047; B31B 2100/0024; B31B 2110/30; B31B 2120/102

(57) ABSTRACT

A container includes a base that includes a bottom wall and side walls. The container also includes a cover that is coupled to and that is hingedly movable relative to a first side wall of the side walls between an open configuration and a closed configuration. The cover is releasably connected to at least a second side wall of the side walls in the closed configuration.

### CROSS-REFERENCE TO RELATED APPLICATIONS

This application claims priority to and the benefit of U.S. Provisional Application No. 63/281,223, filed Nov. 19, 2021, the entire contents of which are herein incorporated by reference in their entirety.

### FIELD

The present disclosure relates to product packaging and, more particularly, to containers for packaging product and blanks and methods for forming the same. More particularly, though not exclusively, the present disclosure relates to hybrid clamshell containers that include a base made of a cellulosic material and a cover made of a plastic material.

### BACKGROUND

In the field of packaging, it is often desirable to provide a container that is capable of holding product for purchase by a consumer and during transport after purchase. It is also desirable for such a container to be capable of being shipped, handled, and displayed prior to purchase. One common type of such container is a clamshell container that includes a tray with a hinged lid. Typically, these containers are made a single material, such as paperboard, plastic or Styrofoam. While containers made of these materials are relatively inexpensive to manufacture, each type of material has inherent disadvantages. Paperboard containers are typically easily recyclable. However, paperboard containers may lack the desired sturdiness for display (e.g., stacking) and/or transport. Plastic and Styrofoam containers are typically more durable than paperboard. However, plastic and Styrofoam containers produce undesirable waste and are more costly to recycle. Accordingly, those skilled in the art continue with research and development efforts in the field of container packaging.

### SUMMARY

Disclosed are a container, a base for the container, a blank for forming the container and/or the base of the container, a method for forming the container from the blank and a method for packaging product. The following is a non-exhaustive list of examples, which may or may not be claimed, of the subject matter according to the present disclosure.

In an example, the disclosed container includes a base that includes a bottom wall and side walls. The container also includes a cover that is coupled to and that is hingedly movable relative to a first side wall of the side walls between an open configuration and a closed configuration. The cover is releasably connected to at least a second side wall of the side walls in the closed configuration.

In an example, the disclosed base for a container includes a bottom wall and side walls extending from the bottom wall. A first side wall of the side walls of the base is configured to be coupled to a cover that is hingedly movable relative to the first side wall between an open configuration and a closed configuration. At least a second side wall of the side walls of the base is configured to be releasably connected to the cover in the closed configuration.

In an example, the disclosed blank for forming the base of the container includes a bottom panel and side panels connected to the bottom panel along fold lines. A first side panel of the side panels is configured for coupling a cover that is hingedly movable relative to the first side panel. A second side panel of the side panels is configured for releasable connecting the cover to the second side panel.

In an example, the disclosed method for forming the container includes steps of: (1) manipulating a blank such that a bottom panel of the blank forms a bottom wall of a base of the container and side panels of the blank form side walls of the base of the container; and (2) coupling a cover to a first side wall of the side walls of the base such that the cover is hingedly movable relative to the first side wall between an open configuration and a closed configuration. The cover is releasably connected to at least a second side wall of the side walls of the base in the closed configuration.

In an example, the disclosed method for packaging product in the container includes steps of: (1) forming a base of the container; (2) coupling a cover to a first side wall of the base; (3) loading product in an internal volume formed by the base; (4) hingedly moving the cover relative to the first side wall from an open configuration to a closed configuration; and (5) releasably connecting the cover to at least a second side wall of the base in the closed configuration.

Other examples of the disclosed container, base, blank and methods will become apparent from the following detailed description, the accompanying drawings, and the appended claims.

### BRIEF DESCRIPTION OF THE DRAWINGS

FIG. 1 is a schematic, front perspective view of an example of a container in a closed configuration;

FIG. 2 is a schematic, back perspective view of an example of the container in the closed configuration;

FIG. 3 is a schematic, top perspective view of an example of the container in an open configuration;

FIG. 4 is a schematic, back perspective view of an example of the container in the closed configuration;

FIG. 5 is a schematic, top perspective view of an example of the container in the open configuration;

FIG. 6 is a schematic, sectional view of an example of a portion of the container in the closed configuration;

FIG. 7 is a schematic, sectional view of an example of a portion of the container in the closed configuration;

FIG. 8 is schematic, plan view of an example of a blank for forming a base of the container;

FIG. 9 is schematic, plan view of an example of the blank for forming the base of the container;

FIG. 10 is schematic, plan view of an example of the blank for forming the base of the container;

FIG. 11 is a schematic, plan view of an example of a cover of the container;

FIG. 12 is schematic, plan view of an example of the blank for forming the base of the container;

FIG. 13 is schematic, plan view of an example of the blank for forming the base of the container;

FIG. 14 is a schematic, plan view of an example of a cover of the container;

FIG. 15 is schematic, plan view of an example of the blank for forming the base of the container;

FIG. 16 is a schematic, plan view of an example of a cover of the container;

FIG. 17 is schematic, plan view of an example of the blank for forming the base of the container;

FIG. 18 is schematic, plan view of an example of the blank for forming the base of the container;

FIG. 19 is a schematic, plan view of an example of a cover of the container;

FIG. 20 is schematic, plan view of an example of the blank for forming the base of the container;

FIG. 21 is a schematic, plan view of an example of a cover of the container;

FIG. 22 is schematic, plan view of an example of the blank for forming the base of the container; and

FIG. 23 is a schematic, plan view of an example of a cover of the container.

### DETAILED DESCRIPTION

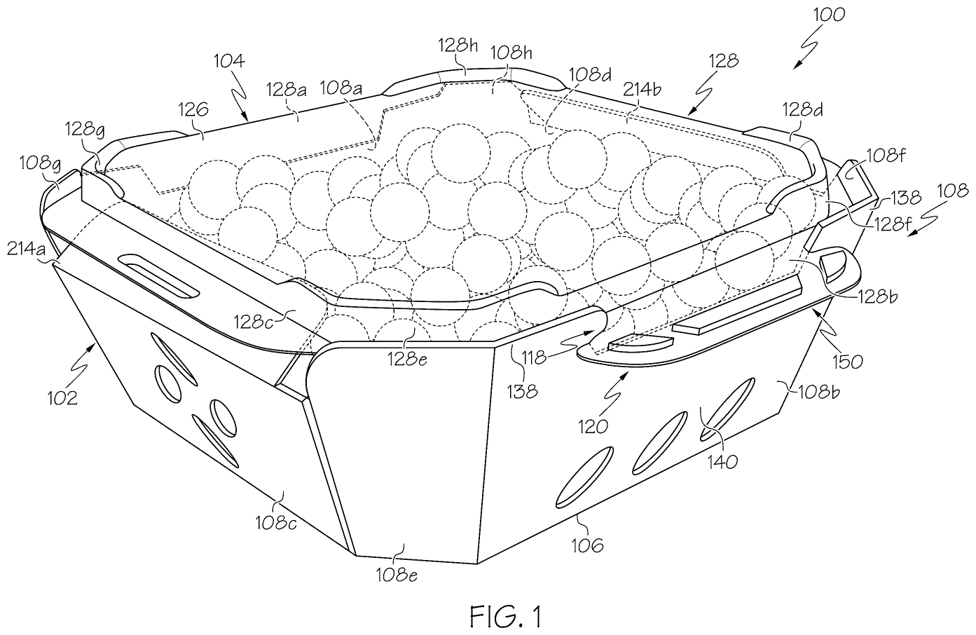

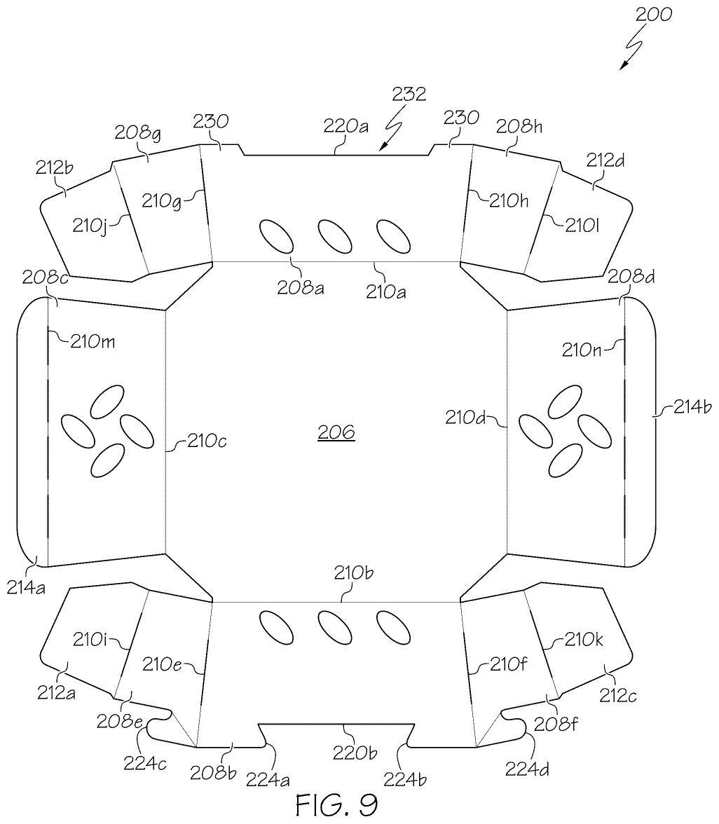

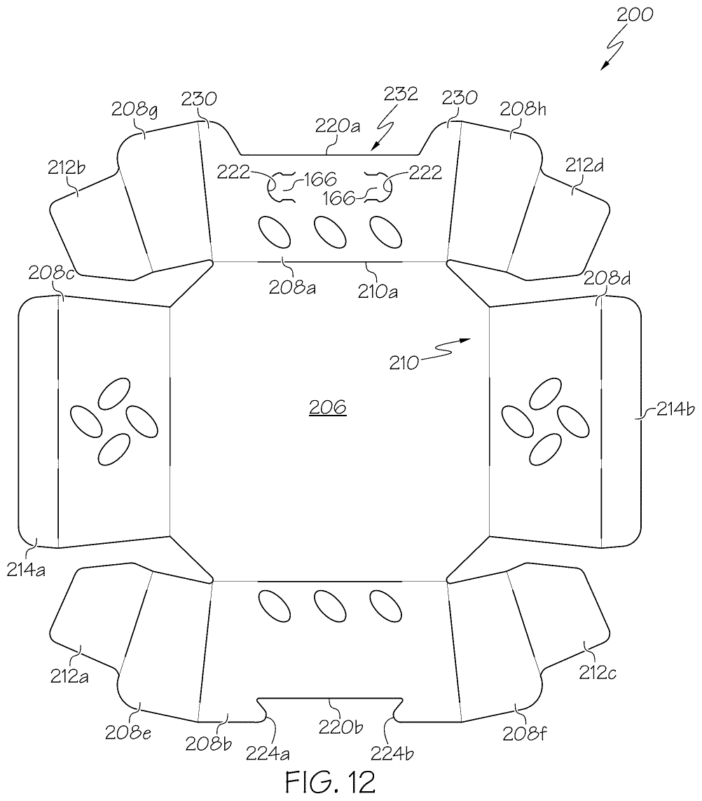

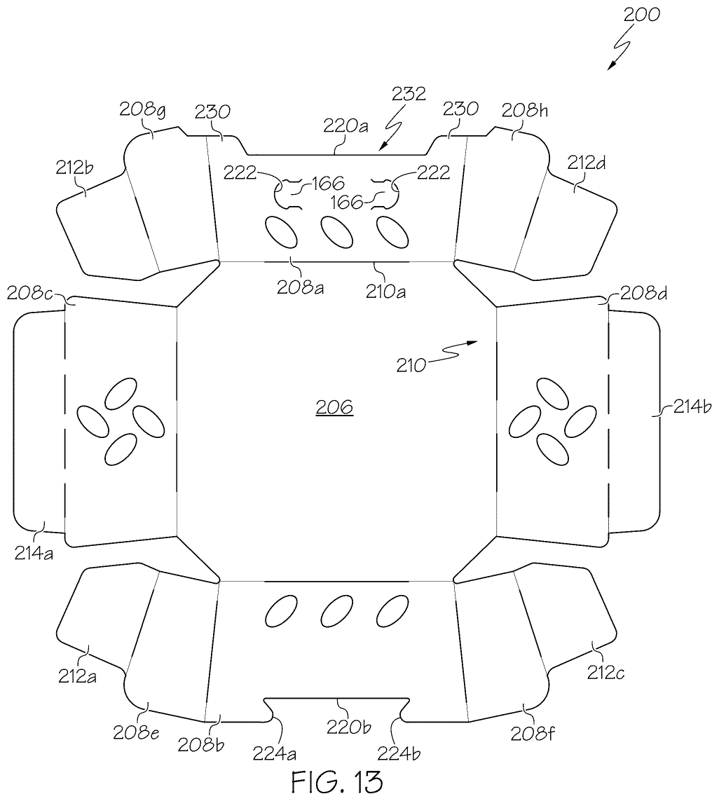

Referring generally to FIGS. 1-7, by way of examples, the present disclosure is directed to a container 100 for packaging product. More particularly, the container 100 takes the form of a hybrid clamshell container that includes a base 102 and a cover 104, which are made of different materials. Referring to FIGS. 8-23, by way of examples, the present disclosure is also directed to a blank 200 that is used to construct or otherwise form the base 102 of the container 100 and the cover 104 of the container 100.

Examples of the container 100 described herein provide various advantages and benefits over traditional clamshell containers, which are typically made of a single material, such as paperboard, plastic, closed-cell extruded polystyrene foam (e.g., Styrofoam®) and the like, and are manufactured as a monolithic structure. As an example, the base 102 and the cover 104 are manufactured independently and as separate components, which are coupled together to form the container 100. This aspect of the container 100 advantageously enables certain features of the base 102 and/or the cover 104 to be designed of modified for a particular application without requiring a complete redesign of an entirety of the container 100. For example, a variety of different configurations of bases 102 may be designed and manufactured for various applications or uses, all of which may be used with a single design of the cover 104 or vice versa. As another example, implementation of the hybrid design of the container 100 in which the base 102 and the cover 104 are made of different materials beneficially provides the ability to tailor the strength, durability and/or structural configuration of the base 102 and/or the cover 104 based on a particular application of the container 100, which may improve the capability of the container 100 to be stacked, shipped, and the like. As another example, implementation of the hybrid design of the container 100 in which the base 102 and the cover 104 are made of different materials beneficially provides a reduction in material waste that is less biodegradable, thus, facilitating a more environmentally friendly container 100.

Referring now to FIGS. 1-7, which illustrate examples of the container 100. In one or more examples, the base 102, which may also be referred to as a tray, includes a bottom wall 106 and side walls 108. The side walls 108 are coupled to or otherwise extend (e.g., upwardly) from the bottom wall 106. Generally, the base 102 includes an interior volume formed by the bottom wall 106 and the side walls 108. A top or upper end of the base 102, opposite the bottom wall 106, is open (e.g., the base 102 includes an open top end) and is formed by upper ends or edged of the side walls 108.

In various examples, the base 102 includes any suitable number of side walls 108 and has any suitable size and/or shape (e.g., cross-sectional geometry or three-dimensional geometry). In one or more examples, as illustrated in FIGS. 1-5, the base 102 includes eight side walls 108 (identified individually as first side wall 108a, second side wall 108b, third side wall 108c, fourth side wall 108d, fifth side wall 108e, sixth side wall 108f, seventh side wall 108g, and eighth side wall 108h). In the illustrated examples, the base 102 has an octagonal shape, in plan view, formed by eight side walls 108. In such examples, directly adjacent ones of the side walls 108 are oblique to each other such that certain ones of the side walls 108 (e.g., fifth side wall 108e, sixth side wall 108f, seventh side wall 108g, and eighth side wall 108h) form or define corner walls of the base 102.

In other examples, the base 102 includes less than eight side walls 108 or more than eight side walls 108. For example, the base 102 may have square or rectangular shape, in plan view, formed by four side walls 108. In such examples, directly adjacent ones of the side walls 108 are approximately perpendicular to each other.

In one or more examples, the side walls 108 are oblique to the bottom wall 106 such that the base 102 has an inverted trapezoidal shape, in cross-section. In one or more examples, the side walls 108 are approximately perpendicular to the bottom wall 106 such that the base 102 has a square or rectangular shape, in cross-section.

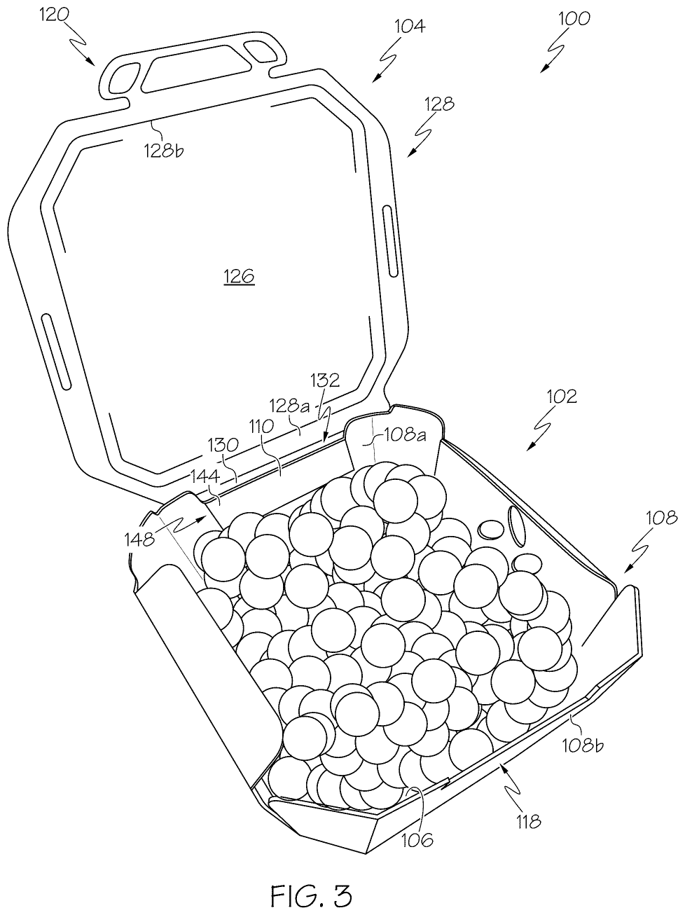

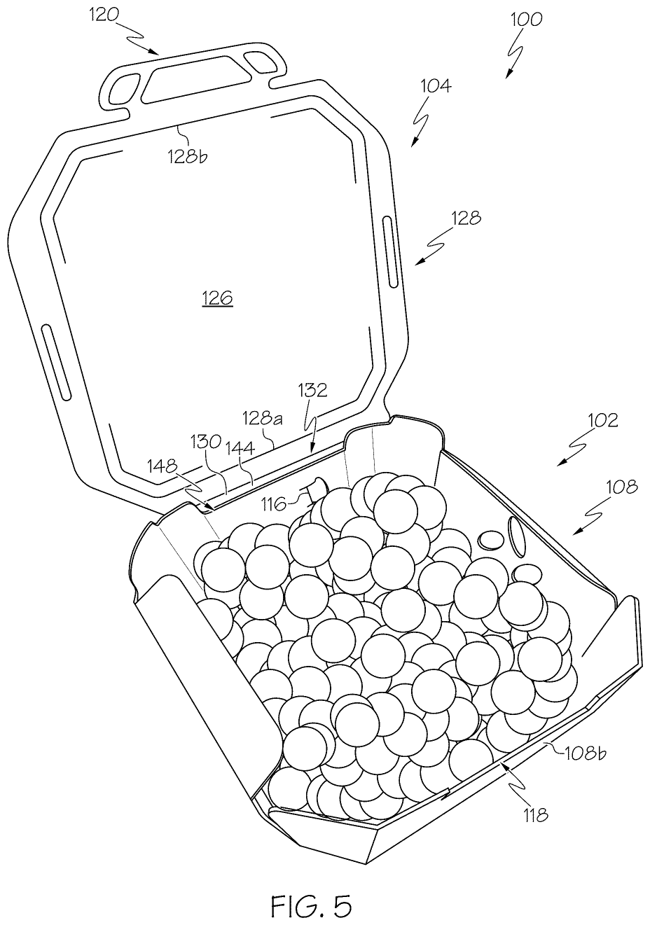

In one or more examples, the cover 104, which may also be referred to as a lid, is coupled to one of the side walls 108 of the base 102, such as the first side wall 108a. In one or more examples, the first side wall 108a of the base 102 is configured to be coupled to the cover 104. The cover 104 is hingedly movable relative to the first side wall 108a between an open configuration (e.g., as shown in FIGS. 3 and 5) and a closed configuration (e.g., as shown in FIGS. 1, 2 and 4). In one or more examples, the cover 104 is releasably connected to at least another one of the side walls 108, such as the second side wall 108b, in the closed configuration. In one or more examples, at least the second side wall 108b of the base 102 is configured to be releasably connected to the cover 104 to maintain the cover 104 in the closed configuration. As such, the container 100 takes the form of or may be referred to as a clamshell-type container.

In one or more examples, the cover 104 includes a top wall 126 and side walls 128. The side walls 128 are coupled to or otherwise extend (e.g., downwardly in the closed configuration) from the top wall 126. In one or more examples, the cover 104 includes an interior volume formed by the top wall 126 and the side walls 128. A bottom or lower end of the cover 104, opposite the top wall 126, is open (e.g., the cover 104 includes an open bottom end) and is formed by lower ends or edged of the side walls 128. However, other structural configurations of the cover 104 are also contemplated. For example, the cover 104 may take the form of a generally planar cover (e.g., formed only of the top wall 126).

Generally, with the base 102 and the cover 104 coupled together and the cover 104 in the closed configuration, the base 102 and the cover 104 form an at least partially enclosed interior volume of the container 100 within which product is housed. For example, the interior volume defined by the base 102 and the interior volume defined by the cover 104 form the interior volume of the container 100.

In various examples, the cover 104 includes any suitable number of side walls 128 and has any suitable size and/or shape (e.g., cross-sectional geometry or three-dimensional geometry). In one or more examples, as illustrated in FIGS. 1-5, the cover 104 includes eight side walls 128 (identified individually as first side wall 128a, second side wall 128b, third side wall 128c, fourth side wall 128d, fifth side wall 128e, sixth side wall 128f, seventh side wall 128g, and eighth side wall 128h). In the illustrated examples, the cover 104 has an octagonal shape, in plan view, formed by eight side walls 128. In such examples, directly adjacent ones of the side walls 128 are oblique to each other such that certain ones of the side walls 128 (e.g., fifth side wall 128e, sixth side wall 128f, seventh side wall 128g, and eighth side wall 128h) form or define corner walls of the cover 104.

In other examples, the cover 104 includes less than eight side walls 128, more than eight side walls 128, or no discernable side walls 128. For example, the cover 104 may have square or rectangular shape, in plan view, formed by four side walls 128. In such examples, directly adjacent ones of the side walls 128 are approximately perpendicular to each other. Generally, the number of side walls 108 of the base 102 and the number of side walls 128 of the cover 104 are the same.

In one or more examples, the side walls 128 are oblique to the top wall 126 such that the cover 104 has a trapezoidal shape, in cross-section, in the closed configuration. In one or more examples, the side walls 128 are approximately perpendicular to the top wall 126 such that the cover 104 has a square or rectangular shape, in cross-section, in the closed configuration.

Generally, the container 100, such as the base 102 and the cover 104, may be made of any suitable material or combination of materials. However, advantageous examples of the container 100 provide a hybrid clamshell container in which the base 102 and the cover 104 are made of different materials. In one or more examples, the base 102 is made of a first material and the cover is made of a second material. In one or more examples, the first material and the second material are different. The container 100 having the base 102 and the cover 104 of different materials may provide advantages not available to traditional clamshell containers made of a single material, such as, but not limited to, a reduction in material costs, a reduction in material waste, an increase in strength and durability, an increase in versatility, and the like.

However, the disclosed container 100 is not limited to the base 102 and the cover 104 being made of different materials. In one or more examples, the base 102 and the cover 104 may be made of the same or substantially the same material.

In one or more examples, the base 102 is made of (e.g., the first material is) a cellulosic material. In one or more examples, the cover 104 is made of (e.g., the second material is) a plastic material. For example, the container 100 takes the form of a hybrid clamshell container having a paperboard base or tray and a plastic cover or lid. The container 100 having the base 102 made of paperboard (e.g., the cellulosic material) and the cover 104 made of plastic (e.g., the plastic material) may provide advantages not available to traditional clamshell containers made of a single material, such as, but not limited, the ability to separately manufacture the base 102 and the cover 104, a reduction in plastic waste, an increase in strength and durability of the cover 104, a more stackable container 100, and the like.

In one or more examples, the cover 104 (e.g., the second material) is transparent. The cover 104 being transparent enables a consumer to easily see the contents of the container 100 (e.g., product) while the container 100 is in the closed configuration and without the necessity of opening the cover 104.

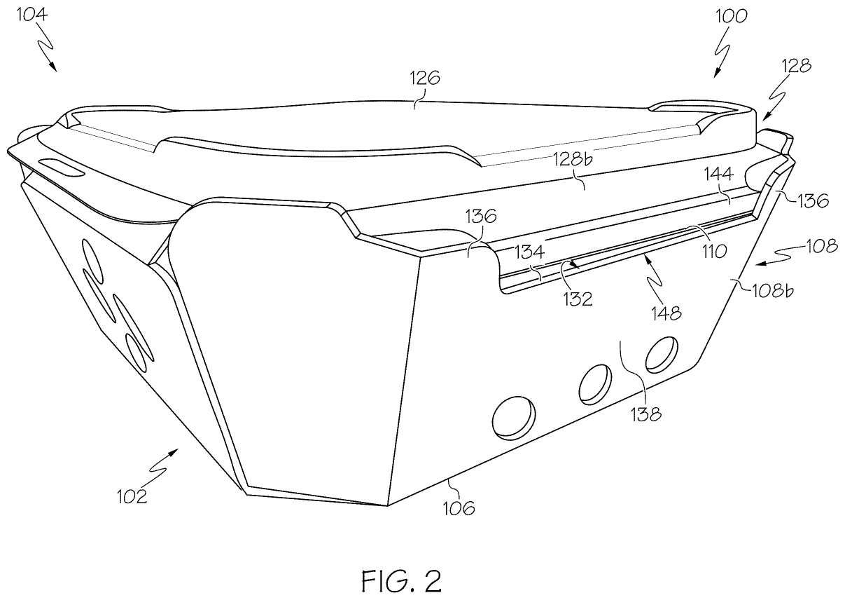

Referring to FIGS. 2-5, in one or more examples, the container 100 incudes a coupling assembly 148. The coupling assembly 148 is configured to couple the base 102 and the cover 104 together. The coupling assembly 148 may have any one of various configurations and/or utilize any one of various means to couple the base 102 and the cover 104 together. In one or more examples, the coupling assembly 148 utilizes an adhesive coupling between a portion of the base 102, such as one of the side walls 108, and a portion of the cover 104. In one or more examples, the coupling assembly 148 utilizes a mechanical coupling between a portion of the base 102, such as one of the side walls 108, and a portion of the cover 104. In one or more examples, the coupling assembly 148 is formed by intercoupling a coupling flap 144 of the cover 104 and one of the side walls 108 (e.g., first side wall 108a) of the base 102.

Referring now to FIGS. 2 and 3, in one or more examples, the cover 104 is adhesively coupled (e.g., adhered) to at least one of the side walls 108 (e.g., the first side wall 108a) of the base 102. For example, the first side wall 108a of the base 102 is configured to be adhesively coupled to the cover 104. The first side wall 108a and the cover 104 may be adhesively coupled together in any one of various ways.

In one or more examples, the cover 104 includes an adhering flap 110. In one or more examples, the adhering flap 110 is adhesively coupled to a portion of a surface of the first side wall 108a. The adhering flap 110 may be adhered to (e.g., glued) to an interior surface (e.g., as shown in FIG. 3) or to an exterior surface of the first side wall 108a. The adhering flap 110 is an example of the coupling flap 144 of the coupling assembly 148. As such, the adhering flap 110, the first side wall 108a, and an adhesive material, in combination, are an example of or form the coupling assembly 148.

In one or more examples, the adhering flap 110 is coupled to or extends outwardly from the first side wall 128a of the cover 104. In one or more examples, the adhering flap 110 is hingedly coupled to the first side wall 128a of the cover 104 or extends from the first side wall 128a of the cover along a predefined or preformed line of weakness 130 (e.g., fold line, hinge line, line of separation or the like) formed in the cover 104. As such, with the cover 104 coupled to the first side wall 108a of the base 102, the cover 104 is hingedly movable relative to the adhering flap 110 to move the cover 104 between the open configuration (e.g., as shown in FIG. 3) and the closed configuration (e.g., as shown in FIG. 2)

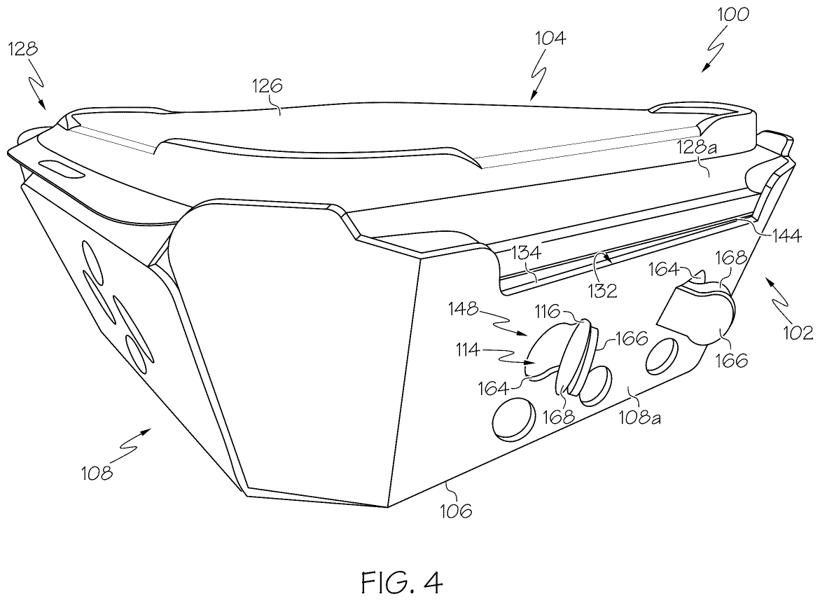

Referring now to FIGS. 4 and 5, in one or more examples, the cover 104 is mechanically coupled to at least one of the side walls 108 (e.g., the first side wall 108a) of the base 102. For example, the first side wall 108a of the base 102 is configured to be mechanically coupled to the cover 104. The first side wall 108a of the base 102 and the cover 104 may be mechanically coupled or otherwise interlocked together in any one of various ways.

In one or more examples, the first side wall 108a includes a locking receiver 114 formed therein. The cover 104 includes a locking flap 116. The locking flap 116 is an example of the coupling flap 144 of the coupling assembly 148. As such, the locking flap 116 and the locking receiver 114, in combination, are an example of or form the coupling assembly 148.

The locking receiver 114 is configured to receive a portion of the locking flap 116. The portion of the locking flap 116 is received by the locking receiver 114 to mechanically couple the cover 104 to the first side wall 108a. In one or more examples, a portion of the locking flap 116 extends through the first side wall 108a when the locking flap 116 is received by the locking receiver 114. The locking flap 116 may extend from an interior to an exterior of the first side wall 108a (e.g., as shown in FIG. 4) or may extend from an exterior to an interior of the first side wall 108a (e.g., as shown in FIG. 5).

In one or more examples, the locking flap 116 is coupled to or extends outwardly from the first side wall 128a of the cover 104. In one or more examples, the locking flap 116 is hingedly coupled to the first side wall 128a of the cover 104 or extends from the first side wall 128a of the cover along a predefined or preformed line of weakness 130 (e.g., fold line, hinge line, line of separation or the like) formed in the cover 104. As such, with the cover 104 coupled to the first side wall 108a of the base 102, the cover 104 is hingedly movable relative to the adhering flap 110 to move the cover 104 between the open configuration (e.g., as shown in FIG. 5) and the closed configuration (e.g., as shown in FIG. 4)

Referring now to FIGS. 2-5, in one or more examples, the first side wall 108a of the base 102 is configured to accommodate or otherwise receive a portion of the cover 104, such as the coupling flap 144, such that the cover 104 can move between the open configuration and the closed configuration without being obstructed by the first side wall 108a. In one or more examples, the first side wall 108a includes a cut out 132 formed in an upper end thereof. The cut out 132 is configured to accommodate the coupling flap 144. For example, an upper edge 134 (e.g., as shown in FIGS. 2 and 4) of the first side wall 108a includes a nonlinear geometry that forms the cut out 132 such that opposing end portions 136 of the first side wall 108a extend beyond a central portion 13 of the first side wall 108a (e.g., as shown in FIGS. 2 and 4).

As illustrated in FIGS. 2 and 3, in one or more examples, the cut out 132 accommodates the adhering flap 110 such that the cover 104 is capable of hingedly moving relative to the adhering flap 110 and the first side wall 108a without being obstructed by the first side wall 108a. For example, the adhering flap 110 is situated between the opposing end portions 136 of the first side wall 108a, within the cut out 134, and a portion of the adhering flap 110 is adhesively coupled to the central portion 138 of the first side wall 108a.

As illustrated in FIGS. 4 and 5, in one or more examples, the cut out 132 accommodates the locking flap 116 such that the cover 104 is capable of hingedly moving relative to the locking flap 116 and the first side wall 108a without being obstructed by the first side wall 108a. For example, the locking flap 116 is situated between the opposing end portions 136 of the first side wall 108a, within the cut out 134, and a portion of the locking flap 116 is mechanically coupled to the central portion 138 of the first side wall 108a, for example, received by the locking receiver 114 formed through the central portion 138 of the first side wall 108a.

Referring now to FIGS. 1, 3 and 5-7, in one or more examples, the container 100 includes a closure assembly 150. The closure assembly 150 is configured to releasably connect (e.g., secure, hold, or otherwise maintain) the cover 104 to the base 102 in the closed configuration. The closure assembly 150 may have any one of various configurations and/or utilize any one of various means to releasably connect the cover 104 to the base 102 in the closed configuration.

Referring to FIGS. 1, 3 and 5, in one or more examples, at least one of the side walls 108 (e.g., the second side wall 108b) of the base 102 includes a latching receiver 118. In one or more examples, the second side wall 108b is opposite the first side wall 108a. The cover 104 includes a latching flap 120. In these examples, the latching receiver 118 and the latching flap 120, in combination, are an example of form at least a portion of the closure assembly 150.

In one or more examples, the latching receiver 118 is configured to receive a portion of the latching flap 120. The portion of the latching flap 120 is received by the latching receiver 118 to releasably connect the cover 104 to the second side wall 108b in the closed configuration (e.g., as shown in FIG. 1). The releasable interlocking engagement of latching flap 120 and the latching receiver 118 may have any one of various configurations.

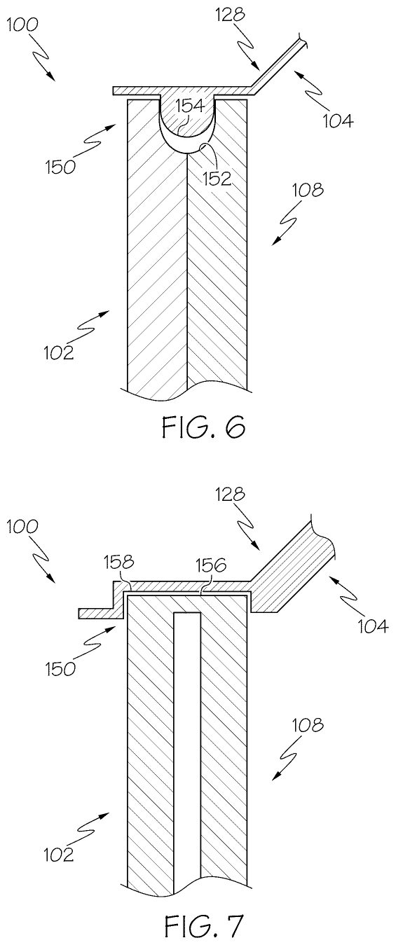

Referring now to FIG. 6, in one or more examples, at least one of the side walls 108 (e.g., the third side wall 108c and/or the fourth side wall 108d) includes a recess 152. The cover 104 includes at least one protrusion 154. In one or more examples, the recess 152 is formed in or depends from an upper edge of the side wall 108. In one or more examples, the protrusion 154 projects outward from a body of the cover 104, such as from one of the side walls 128 or the top wall 126 of the cover 104. The recess 152 is configured to receive at least a portion of the protrusion 154. For example, the protrusion 154 is received by the recess 152 when the cover 104 is in the closed configuration. In these examples, the recess 152 and the protrusion 154, in combination, are an example of form at least a portion of the closure assembly 150.

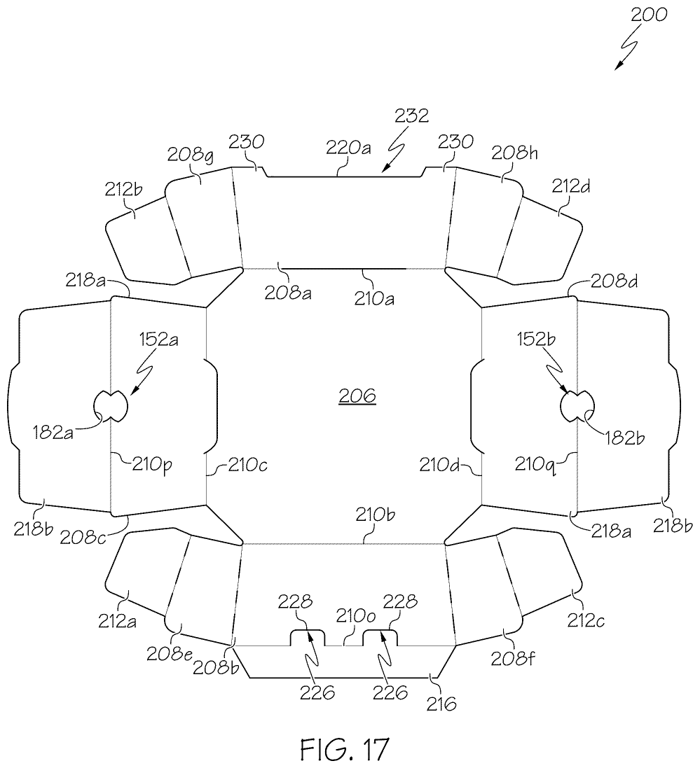

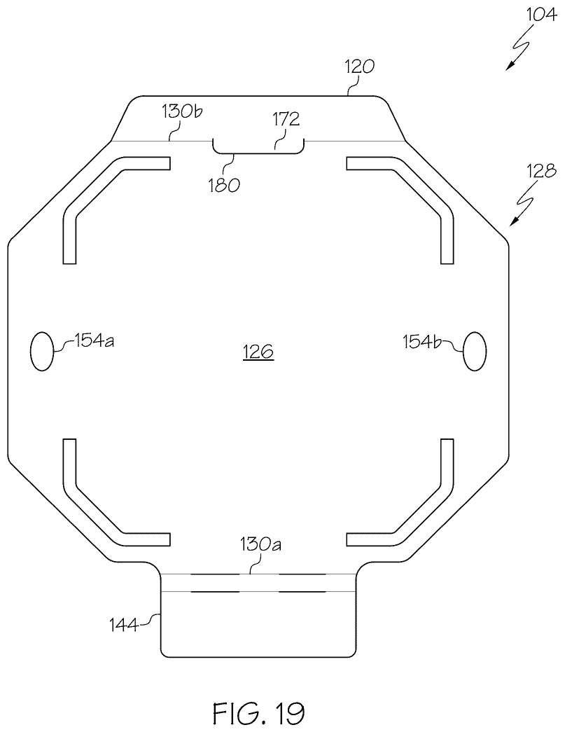

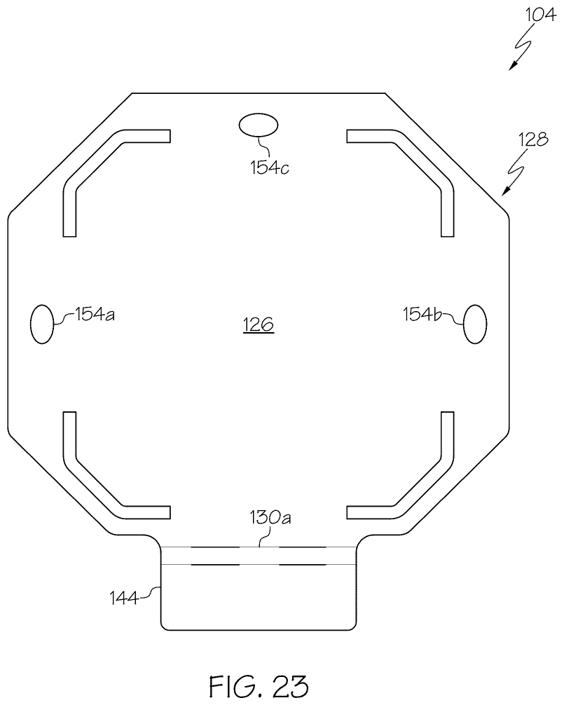

Referring now to FIGS. 6, 17, 18 and 22, in one or more examples, the third side wall 108c includes a first recess 152a and the fourth side wall 108d includes a second recess 152b (e.g., as depicted by the examples of the blank 200 shown in FIGS. 17, 18 and 22). The third side wall 108c is opposite the fourth side wall 108d. In one or more examples, the first recess 152a and the second recess 152b are directly opposite each other relative to the base 102. In one or more examples, the cover 104 includes a first protrusion 154a and a second protrusion 154b (e.g., as shown in FIGS. 19 and 23) that is opposite the first protrusion 154a. The first protrusion 154a is received by the first recess 152a and the second protrusion 154b is received by the second recess 152b when the cover 104 is in the closed configuration.

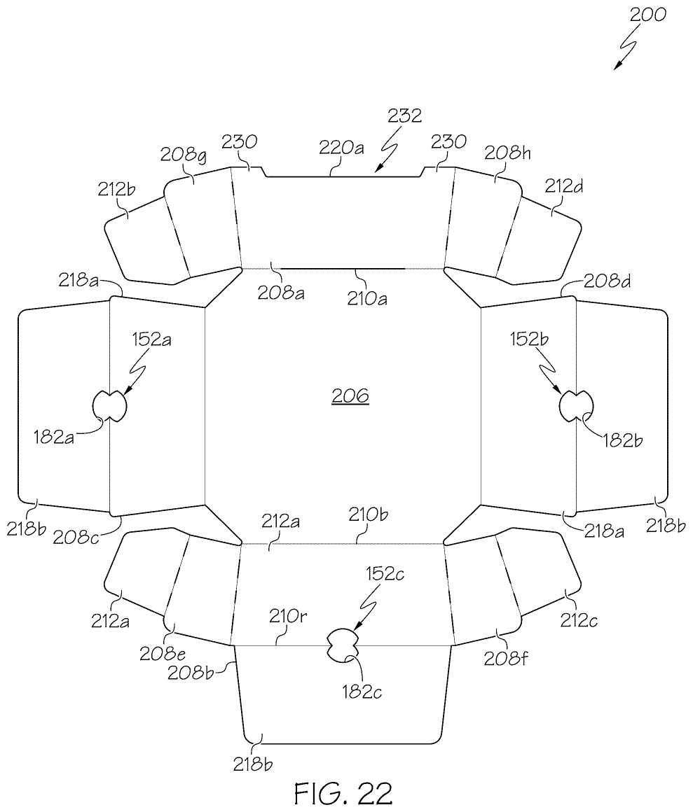

Referring now to FIGS. 6, 22 and 23, in one or more examples, the second side wall 108b includes a third recess 152c (e.g., as depicted by the example of the blank 200 shown in FIGS. 22). In one or more examples, the cover 104 includes a third protrusion 154c (e.g., as shown in FIG. 23). The third protrusion 154c is received by the third recess 152c when the cover 104 is in the closed configuration.

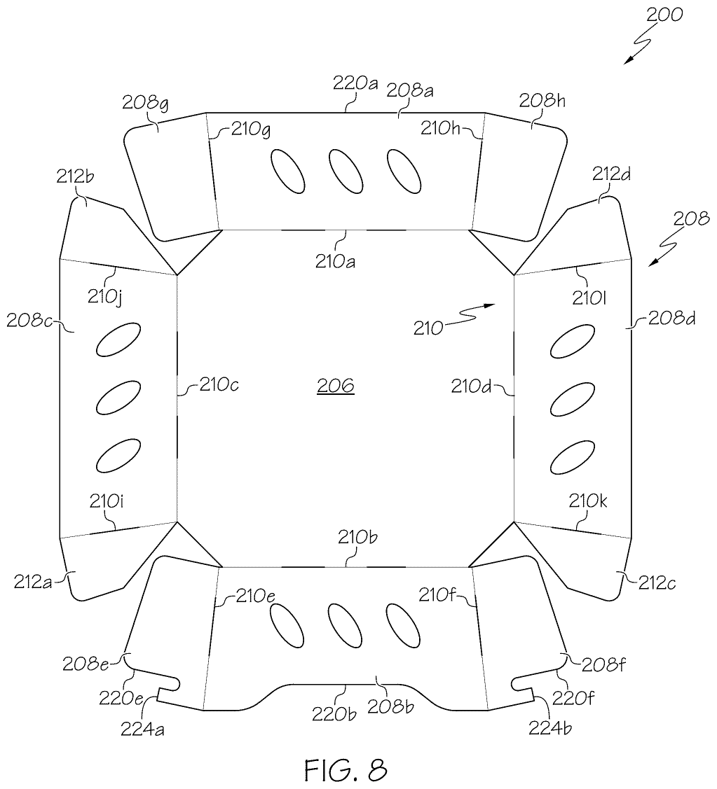

Referring now to FIG. 7, in one or more examples, at least one of the side walls 108 of the base 102 includes a tongue 156. The cover 104 includes a groove 158 formed therein. In one or more examples, the tongue 156 is located along, extends along, or is formed by an upper edge of the side wall 108. In one or more examples, the groove 158 is formed in or depends from a portion of the body of the cover 104, such as one of the side walls 128 or the top wall 126 of the cover 104. The tongue 156 is configured to be received by the groove 158. For example, the tongue 156 is received by the groove 158 when the cover 104 is in the closed configuration. In these examples, the tongue 156 and the groove 158, in combination, are an example of form at least a portion of the closure assembly 150.

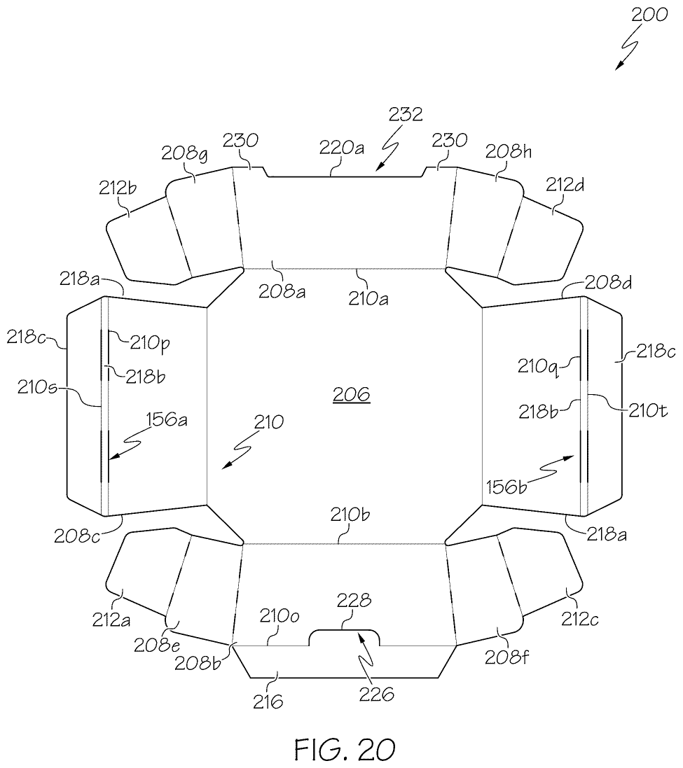

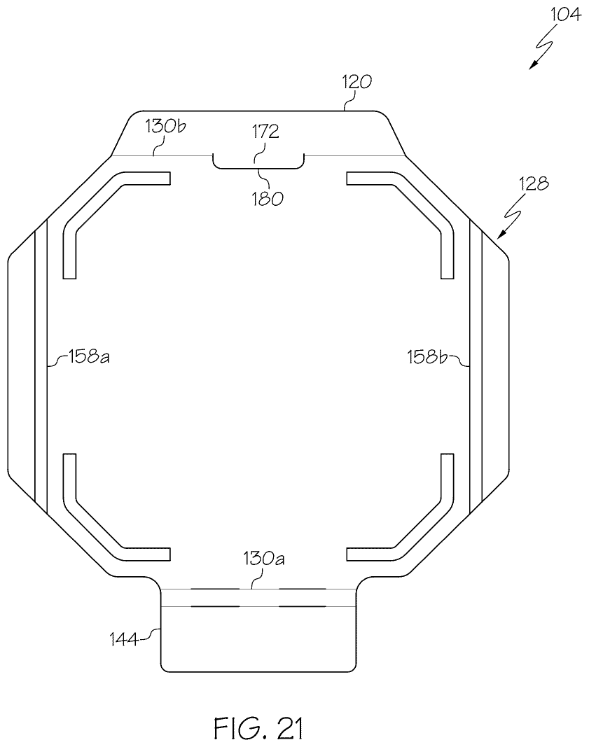

Referring now to FIGS. 7, 20 and 21, the third side wall 108c includes a first tongue 156a and the fourth side wall 108d includes a second tongue 156b (e.g., as depicted by the example of the blank 200 shown in FIG. 20). The third side wall 108c is opposite the fourth side wall 108d. In one or more examples, the first tongue 156a and the second tongue 156b are directly opposite each other relative to the base 102. In one or more examples, the cover 104 includes a first groove 158a and a second groove 158b (e.g., as shown in FIG. 21) that is opposite the first groove 158a. At least a portion of the first tongue 156a is received by the first groove 158a and at least a portion of the second tongue 156b is received by the second groove 158b when the cover 104 is in the closed configuration.

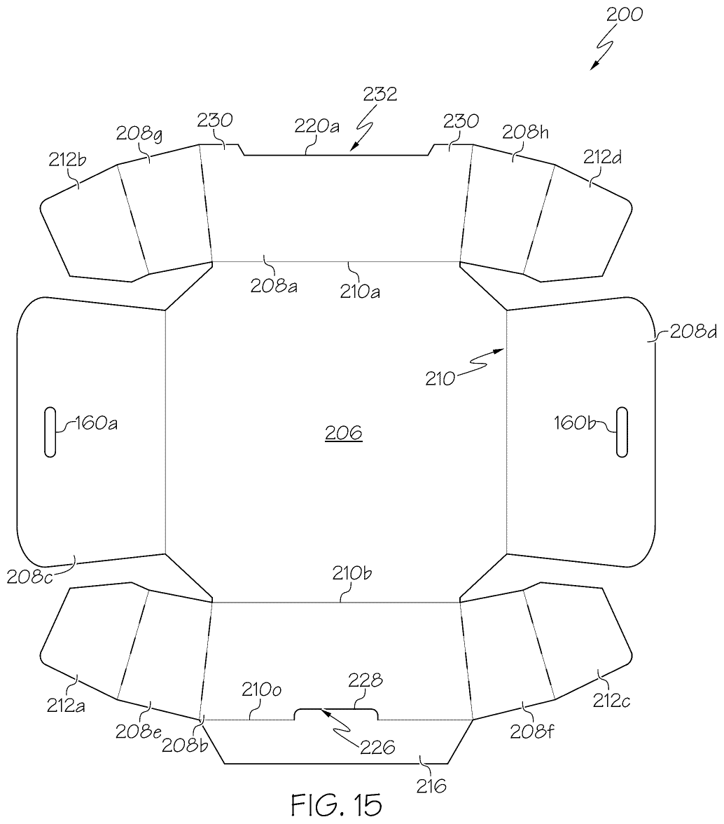

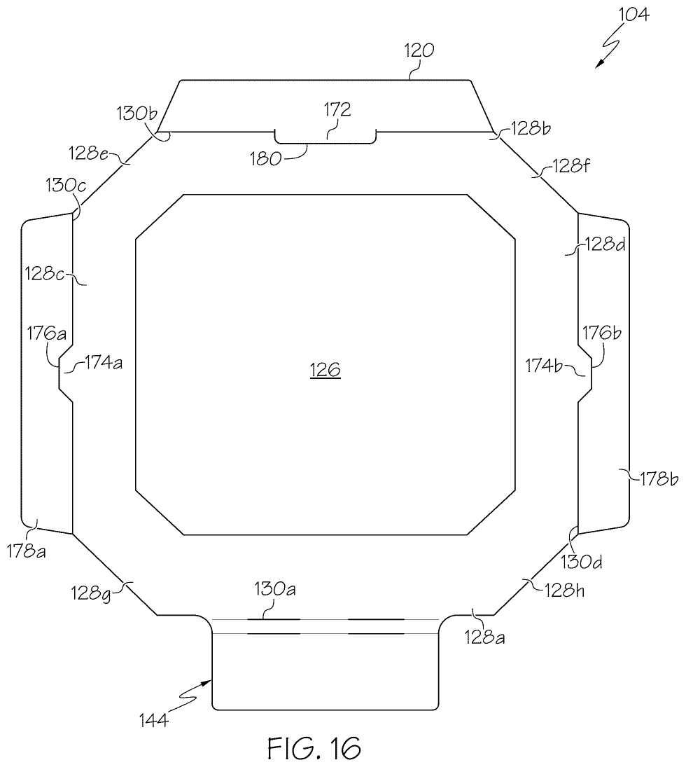

In one or more examples, the closure assembly 150 of the container 100 may include a combination of different elements as described herein above and shown in FIGS. 1, 6 and 7. As an example, the closure assembly 150 of the container 100 may include the latching receiver 118 of the base 102 and the latching flap 120 of the cover 104 (e.g., as shown in FIGS. 1 and 8-14). As another example, the closure assembly 150 of the container 100 may include the latching receiver 118 of the base 102 and the latching flap 120 of the cover 104 in combination with the recess 152 formed in at least one of the side walls 108 and the protrusion 154 projecting from the cover 104 (e.g., as shown in FIGS. 6, 17-19, 22 and 23). As another example, the closure assembly 150 of the container 100 may include the latching receiver 118 of the base 102 and the latching flap 120 of the cover 104 in combination with the tongue 156 formed by at least one of the side walls 108 and the groove 158 formed in the cover 104 (e.g., as shown in FIGS. 7, 20 and 21). As another example, the closure assembly 150 of the container 100 may include the latching receiver 118 of the base 102 and the latching flap 120 of the cover 104 in combination with a retaining aperture formed through at least one of the side walls 108 (e.g., first retaining aperture 160a formed through the third side wall 108c and second retaining aperture 160b formed through the fourth side wall 108d as depicted by the example of the blank 200 shown in FIG. 15) and a retaining tab projecting from the cover 104 (e.g., first retaining tab 162a projecting from the third side wall 128c and second retaining tab 162b projecting from the fourth side wall 128d as shown in FIG. 16). Various other combinations of the examples of engaging elements forming the closure assembly 150 are also contemplated.

The various examples of the closure assembly 150 provide alternatives for releasably connecting the cover 104 to the base 102 in the closed configuration. Additionally, the examples of the closure assembly 150 also provide alternatives for maintaining the cover 104 in a desired position relative to the base 102.

Referring now to FIGS. 1, 2 and 4, in one or more examples, at least one of the side walls 108 is configured to support the cover 104 in the closed configuration. For example, the cover 104 is supported by an upper portion of at least one of the side walls 108 in the closed configuration. In one or more examples, the first side wall 108a supports the cover 104 via the adhesive coupling (e.g., as shown in FIG. 2) or by the mechanical coupling (e.g., as shown in FIG. 4). In one or more examples, an upper portion of the second side wall 108b supports the cover 104 via engagement of the latching flap 120 and the latching receiver 118. In one or more examples, the third side wall 108c and the fourth side wall 108d support the cover 104 via engaging contact with a portion of the cover 104, such as with the top wall 126 or a respective one of the third side wall 128c and fourth side wall 128d of the cover 104.

In one or more examples, the base 102 is configured to receive a portion of cover 104 between at least two of the side walls 108 of the base 102 in the closed configuration. For example, a portion of the cover 104 is situated in the base 102 and between at least two of the side walls 108 of the base 102 in the closed configuration. In one or more examples, at least one of the side walls 128 of the cover 104 is situated inward of a corresponding one of the side walls 108 of the base 102 in the closed configuration. This configuration enables the base 102 to hold the cover 104 in a desired or proper position relative to the base 102 and prevents movement of the cover 104 relative to the base 102 in the closed configuration, which could result in inadvertent release of the latching flap 120 from the latching receiver 118 and undesirable movement of the cover 104 from the closed configuration to the open configuration.

In an example, a portion of first side wall 128a of the cover 104 is situated inward of or is located at an interior surface of a portion of the first side wall 108a of the base 102, such as upper portions of the opposing end portions 136 (e.g., as shown in FIGS. 2 and 4) of the first side wall 108a. A portion of second side wall 128b of the cover 104 is situated inward of or is located at an interior surface of a portion of the second side wall 108b of the base 102, such as upper portions of opposing end portions 140 of the second side wall 108b (e.g., as shown in FIG. 1). Portions of fifth side wall 128e, the sixth side wall 128f, the seventh side wall 128g and the eighth side wall 128h of the cover 104 are situated inward of or are located at an interior surface of respective ones of the fifth side wall 108e, the sixth side wall 108f, the seventh side wall 108g and the eighth side wall 108h of the base 102, such as upper portions of such side walls 108 (e.g., as shown in FIG. 1).

In one or more examples, a portion of at least one of the side walls 108 of the base 102 is configured to be situated in the cover 104 in the closed configuration. For example, a portion of at least one of the side walls 108 is situated in the cover 104 in the closed configuration. In one or more examples, at least one of the side walls 108 of the base 102 is situated inward of a corresponding one of the side walls 128 of the cover 104 in the closed configuration. This configuration enables the base 102 to structurally support the cover 104 in the desired or proper position relative to the base 102 and further prevents movement of the cover 104 relative to the base 102 in the closed configuration, which could result in inadvertent release of the latching flap 120 from the latching receiver 118 and undesirable movement of the cover 104 from the closed configuration to the open configuration. Additionally, this configuration reduces any gaps between the base 102 and the cover 104 in the closed configuration, which better retains product within the container 100 and/or prevents product from accidentally escaping the container 100.

In other examples, the base 102 and/or the cover 104 may include additional or alternative features or elements that facilitate the releasable connection of the cover 104 to the base 102 in the closed configuration, that hold the cover 104 in a proper position relative to the base 102 in the closed configuration, and/or that support the cover 104 in the closed configuration. Such additional or alternative features and elements are described herein below with reference to examples of the blank 200 for forming the container 100. While such additional or alternative features and elements may not be explicitly shown in the examples of the container 100 illustrated in FIGS. 1-7, it can be appreciated that such additional or alternative features and elements illustrated and described with reference to the blank 200 and the cover 104 form the same additional or alternative features and elements in the container 100 formed from base 102, formed from the blank 200, and the cover 104.

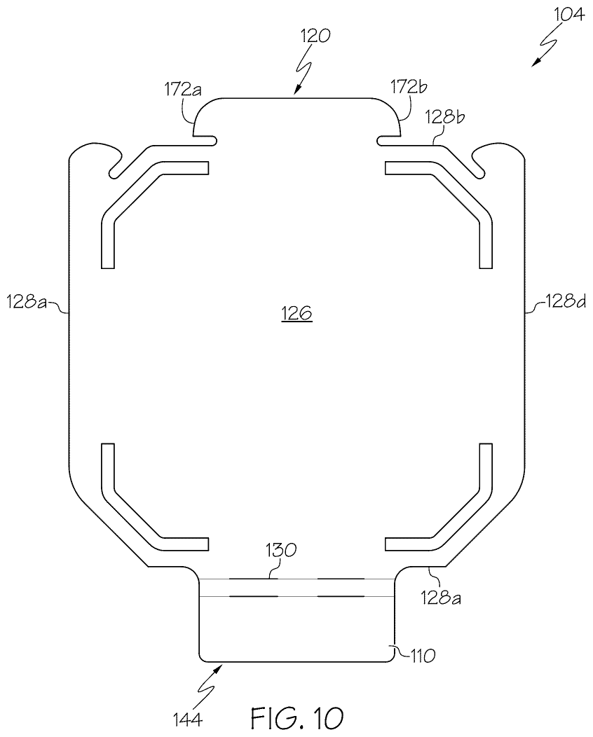

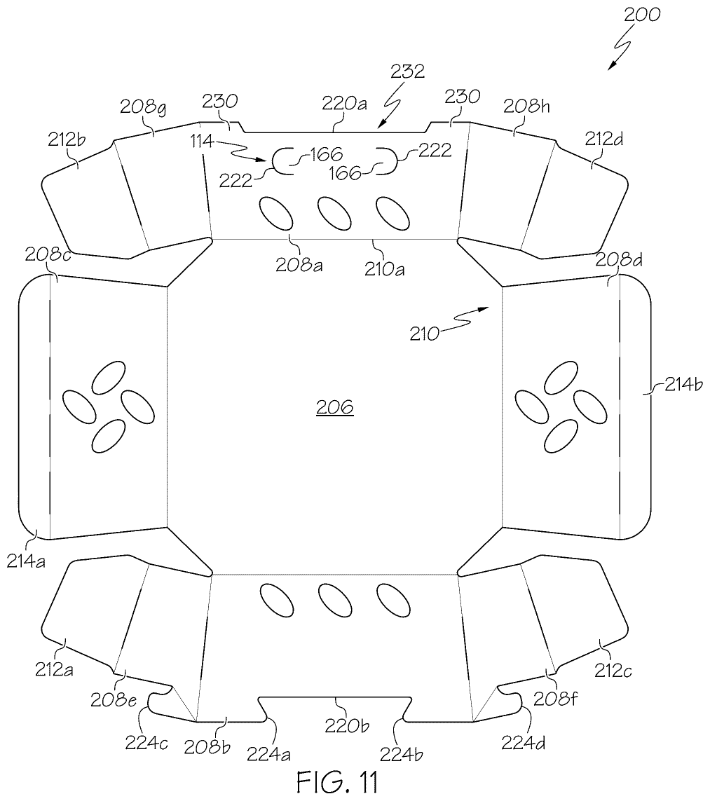

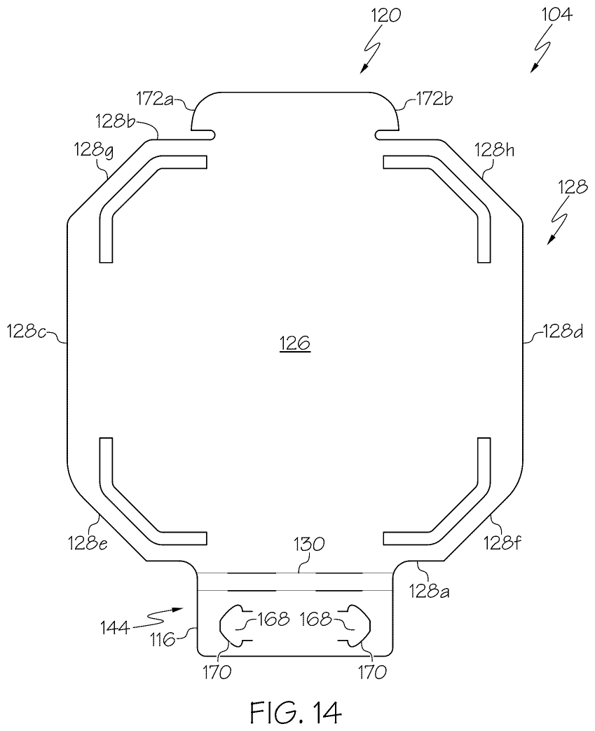

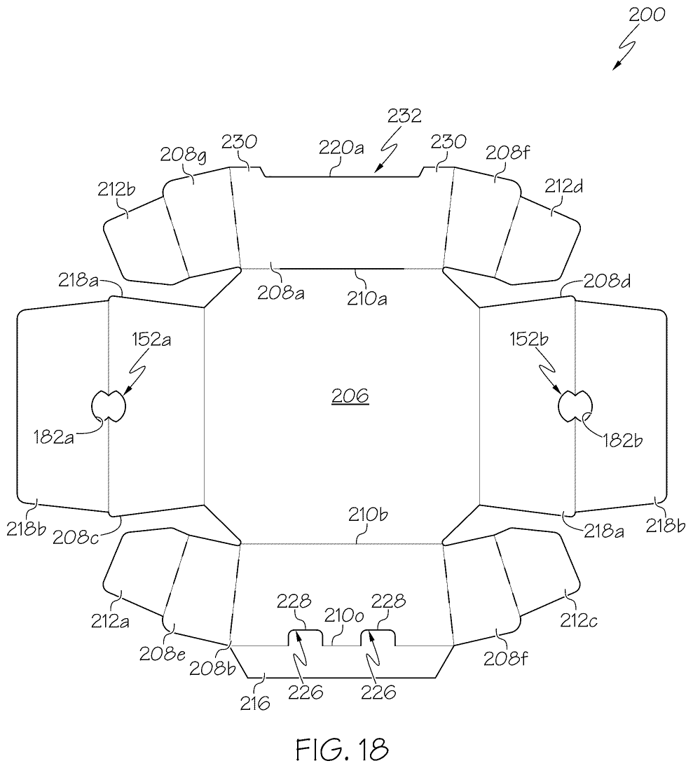

Referring now to FIGS. 8, 9, 10, 11, 12, 13, 15, 17, 18, 20 and 22, which illustrate examples of the blank 200 for forming the base 102, and to FIGS. 10, 14, 16, 19, 21 and 23, which illustrate examples of the cover 104 used with respective ones of the examples of the blank 200 to form the container 100. For instance, the examples of the blank 200 for forming the base 102 (e.g., and the base 102 formed from the blank 200) shown in FIGS. 7 and 8 and the example of the cover 104 shown in FIG. 9 may be designed to be used together. The examples of the blank 200 for forming the base 102 (e.g., and the base 102 formed from the blank 200) shown in FIGS. 11-13 and the example of the cover 104 shown in FIG. 14 may be designed to be used together. The example of the blank 200 for forming the base 102 (e.g., and the base 102 formed from the blank 200) shown in FIG. 15 and the example of the cover 104 shown in FIG. 16 may be designed to be used together. The examples of the blank 200 for forming the base 102 (e.g., and the base 102 formed from the blank 200) shown in FIGS. 17 and 18 and the example of the cover 104 shown in FIG. 19 may be designed to be used together. The example of the blank 200 for forming the base 102 (e.g., and the base 102 formed from the blank 200) shown in FIG. 20 and the example of the cover 104 shown in FIG. 21 may be designed to be used together. The example of the blank 200 for forming the base 102 (e.g., and the base 102 formed from the blank 200) shown in FIG. 22 and the example of the cover 104 shown in FIG. 23 may be designed to be used together.

Referring generally to FIGS. 8, 9, 11-13, 15, 17, 18, 20 and 22, the blank 200 includes a plurality of panels that are connected to each other along a plurality of fold lines. The panels are configured to hingedly move or otherwise be folded about the fold lines relative to each other and to be connected together to construct, erect, assemble or otherwise form the base 102 from the blank 200. Generally, the panels of the blank 200 form or define the walls of the container 100. As such, for the purpose of the present disclosure, the terms “wall” and “panel,” when referring to the base 102 and the blank 200, may be interchangeable and refer to essentially the same structural element, albeit in a different configuration.

In one or more examples, the blank 200 includes a bottom panel 206 and side panels 208. At least a portion of the side panels 208 are connected to or extend from the bottom panel 206 along respective fold lines 210. The bottom panel 206 corresponds to or forms the bottom wall 106 of the base 102 formed from the blank 200 and may have any desired perimeter shape or geometry. The side panels 208 correspond to or form the side walls 108 of the base 102 formed from the blank 200. The blank 200 may include any suitable number of side panels 208 depending, for example, on the size and/or shape of the base 102 formed by the blank 200. Generally, the number of side panels 208 of the blank 200 and the number of side walls 108 of the base 102 formed from the blank 200 are the same.

In the illustrated examples, the blank 200 includes the bottom panel 206 having eight edges (e.g., has an octagonal shape in plan view). The blank 200 also includes eight side panels 208 (identified individually as first side panel 208a, second side panel 208b, third side panel 208c, fourth side panel 208d, fifth side panel 208e, sixth side panel 208f, seventh side panel 208g, and eighth side panel 208h).

In one or more examples, the first side panel 208a is connected to the bottom panel 206 and is hingedly movable relative to the bottom panel 206 along fold line 210a. The first side panel 208a corresponds to or forms at least a portion of the first side wall 108a of the base 102 formed from the blank 200.

The second side panel 208b is connected to the bottom panel 206, opposite the first side panel 208a, and is hingedly movable relative to the bottom panel 206 along fold line 210b. The second side panel 208b corresponds to or forms at least a portion of the second side wall 108b of the base 102 formed from the blank 200.

The third side panel 208c is connected to the bottom panel 206 and is hingedly movable relative to the bottom panel 206 along fold line 210c. The third side panel 208c corresponds to or forms at least a portion of the third side wall 108c of the base 102 formed from the blank 200.

The fourth side panel 208d is connected to the bottom panel 206, opposite the first side panel 208a, and is hingedly movable relative to the bottom panel 206 along fold line 210b. The fourth side panel 208d corresponds to or forms at least a portion of the fourth side wall 108d of the base 102 formed from the blank 200.

The fifth side panel 208e is connected to the second side panel 208b and is hingedly movable relative to the second side panel 208b along fold line 210e. The fifth side panel 208e corresponds to or forms at least a portion of the fifth side wall 108e of the base 102 formed from the blank 200.

The sixth side panel 208f is connected to the second side panel 208b, opposite the fifth side panel 208e, and is hingedly movable relative to the second side panel 208b along fold line 210f. The sixth side panel 208f corresponds to or forms at least a portion of the sixth side wall 108f of the base 102 formed from the blank 200.

The seventh side panel 208g is connected to the first side panel 208a and is hingedly movable relative to the first side panel 208a along fold line 210g. The seventh side panel 208g corresponds to or forms at least a portion of the seventh side wall 108g of the base 102 formed from the blank 200.

The eighth side panel 208h is connected to the first side panel 208a, opposite the seventh side panel 208g, and is hingedly movable relative to the first side panel 208a along fold line 210h. The eighth side panel 208h corresponds to or forms at least a portion of the eighth side wall 108h of the base 102 formed from the blank 200.

In one or more examples, the blank 200 also includes connecting flap 212 that connect a portion of the side panels 208 together when the blank 200 is assembled to form the base 102 and hold the side walls 108 of the base 102 in the constructed configuration after formation.

Referring briefly to FIG. 8, in one or more examples, a first connecting flap 212a is connected to the third side panel 208c and is hingedly movable relative to the third side panel 208c along fold line 210i. When the base 102 is formed from the blank 200, the first connecting flap 212a is coupled to the fifth side panel 208e, for example, via an adhesive (e.g., the first connecting flap 212a is a glue flap) or other suitable fastening technique. In one or more examples, the first connecting flap 212a and the fifth side panel 208e correspond to or form at least a portion of the fifth side wall 108e of the base 102 formed from the blank 200 (e.g., a two-layer wall).

In one or more examples, a second connecting flap 212b is connected to the third side panel 208c, opposite the first connecting flap 212a, and is hingedly movable relative to the third side panel 208c along fold line 210j. When the base 102 is formed from the blank 200, the second connecting flap 212b is coupled to the seventh side panel 208g, for example, via an adhesive (e.g., the second connecting flap 212b is a glue flap) or other suitable fastening technique. In one or more examples, the second connecting flap 212b and the seventh side panel 208g correspond to or form at least a portion of the seventh side wall 108g of the base 102 formed from the blank 200 (e.g., a two-layer wall).

In one or more examples, a third connecting flap 212c is connected to the fourth side panel 208d and is hingedly movable relative to the fourth side panel 208d along fold line 210k. When the base 102 is formed from the blank 200, the third connecting flap 212c is coupled to the sixth side panel 208f, for example, via an adhesive (e.g., the third connecting flap 212c is a glue flap) or other suitable fastening technique. In one or more examples, the third connecting flap 212c and the sixth side panel 208f correspond to or form at least a portion of the sixth side wall 108f of the base 102 formed from the blank 200 (e.g., a two-layer wall).

In one or more examples, a fourth connecting flap 212d is connected to the fourth side panel 208d, opposite the third connecting flap 212c, and is hingedly movable relative to the fourth side panel 208d along fold line 2101. When the base 102 is formed from the blank 200, the fourth connecting flap 212d is coupled to the eighth side panel 208h, for example, via an adhesive (e.g., the fourth connecting flap 212d is a glue flap) or other suitable fastening technique. In one or more examples, the fourth connecting flap 212d and the eighth side panel 208h correspond to or form at least a portion of the eighth side wall 108h of the base 102 formed from the blank 200 (e.g., a two-layer wall).

Referring briefly to FIGS. 9, 11-13, 15, 17, 18, 20 and 22, in one or more examples, the first connecting flap 212a is connected to the fifth side panel 208e and is hingedly movable relative to the fifth side panel 208e along fold line 210i. When the base 102 is formed from the blank 200, the first connecting flap 212a is coupled to the third side panel 208c, for example, via an adhesive (e.g., the first connecting flap 212a is a glue flap) or other suitable fastening technique. In one or more examples, the first connecting flap 212a and the third side panel 208c correspond to or form at least a portion of the third side wall 108c of the base 102 formed from the blank 200 (e.g., a two-layer wall).

In one or more examples, the second connecting flap 212b is connected to the seventh side panel 208g and is hingedly movable relative to the seventh side panel 208g along fold line 210j. When the base 102 is formed from the blank 200, the second connecting flap 212b is coupled to the third side panel 208c, for example, via an adhesive (e.g., the second connecting flap 212b is a glue flap) or other suitable fastening technique. In one or more examples, the second connecting flap 212b and the third side panel 208c correspond to or form at least a portion of the third side wall 108c of the base 102 formed from the blank 200 (e.g., a two-layer wall).

In one or more examples, the third connecting flap 212c is connected to the sixth side panel 208f and is hingedly movable relative to the sixth side panel 208f along fold line 210k. When the base 102 is formed from the blank 200, the third connecting flap 212c is coupled to the fourth side panel 208d, for example, via an adhesive (e.g., the third connecting flap 212c is a glue flap) or other suitable fastening technique. In one or more examples, the third connecting flap 212c and the fourth side panel 208d correspond to or form at least a portion of the fourth side wall 108d of the base 102 formed from the blank 200 (e.g., a two-layer wall).

In one or more examples, the fourth connecting flap 212d is connected to the eighth side panel 208h and is hingedly movable relative to the eighth side panel 208h along fold line 210l. When the base 102 is formed from the blank 200, the fourth connecting flap 212d is coupled to the fourth side panel 208d, for example, via an adhesive (e.g., the fourth connecting flap 212d is a glue flap) or other suitable fastening technique. In one or more examples, the fourth connecting flap 212d and the fourth side panel 208d correspond to or form at least a portion of the fourth side wall 108d of the base 102 formed from the blank 200 (e.g., a two-layer wall).

In one or more examples, the first side panel 208a includes edge 220a that is opposite fold line 210a. When the base 102 is formed from the blank 200, edge 220a of the first side panel 208a forms the upper edge 134 of the first side wall 108a of the base 102. In one or more examples, a portion of the cover 104 folds over the upper edge 134 of the first side wall 108a (e.g., edge 220a of the first side panel 208a) when the cover 104 is hingedly moved to the open configuration, such as when the coupling flap 144 (e.g., as shown in FIGS. 3, 5, 10, 14, 16, 19, 21 and 23) of the cover 104 is coupled to an interior surface of the first side wall 108a of the base 102. In one or more examples, a portion of the cover 104 folds over the upper edge 134 of the first side wall 108a (e.g., edge 220a of the first side panel 208a) when the cover 104 is hingedly moved to the closed configuration, such as when the coupling flap 144 of the cover 104 is coupled to an exterior surface of the first side wall 108a of the base 102.

Referring to FIGS. 9, 11-13, 15, 17, 18, 20 and 22, in one or more examples, edge 220a of the first side panel 208a is nonlinear and includes a geometry configured to accommodate a portion of the cover 104 when the base 102 is formed from the blank 200 and the cover 104 is coupled (e.g., adhesively or mechanically) to the first side wall 108a and hingedly moved between the open configuration and the closed configuration. In one or more examples, the first side panel 208a includes a cut out 226 formed in a central portion of the first side panel 208a between opposed end portions of the first side panel 208a. The cut out 226 in the first side panel 208a forms the cut out 132 in the first side wall 108a of the base 102 formed from the blank 200. The cut out 226 is a recess or other opening that depends from or is formed by the geometry of edge 220a of the first side panel 208a. As such, when the base 102 is formed from the blank 200, portions of the upper edge 134 of the end portions 136 of the first side wall 108a extend beyond a portion of the upper edge 134 of the central portion 138 of the first side wall 108a.

Referring now to FIGS. 10, 14, 16, 19, 21 and 23, in one or more examples, the cover 104 includes the coupling flap 144. The coupling flap 144 is configured to be coupled (e.g., adhesively or mechanically) to the first side wall 108a of the base 102. The adhering flap 110 (e.g., as shown in FIGS. 2, 3, 10, 16, 19, 21 and 23) and the locking flap 116 (e.g., as shown in FIGS. 4, 5 and 14) are examples of the coupling flap 144.

In one or more examples, the coupling flap 144 extends from a body of the cover 104. For example, the coupling flap 144 extends from the first side wall 128a of the cover 104. In one or more examples, the coupling flap 144 extends from or is coupled to the body of the cover 104 (e.g., the first side wall 128a of the cover 104) along the line of weakness 130. In one or more examples, the line of weakness 130 includes or is formed by a pair of parallel lines of weakness that enable the cover 104 to fold over the first side wall 108a of the base 102 when moved between the open configuration and the closed configuration.

In one or more examples, the coupling flap 144 (e.g., the adhering flap 110 as shown in FIGS. 2, 3, 10, 16, 19, 21 and 23 or the locking flap 116 as shown in FIGS. 4, 5 and 14) is coupled to the first side wall 108a of the base 102 formed from the blank 200. The cut out 226 in the first side panel 208a (e.g., cut out 132 in the first side wall 108a) is configured (e.g., sized and/or shaped) to receive and/or otherwise accommodate a portion of the coupling flap 144 when the coupling flap 144 is coupled to the central portion 138 of the first side wall 108a.

FIGS. 8, 9, 15, 17, 18, 20 and 22 illustrate examples of the blank 200 for forming the base 102 and FIGS. 10, 16, 19, 21 and 23 illustrate examples of the cover 104 that utilize an adhesively coupled coupling assembly 148 to couple the cover 104 and the base 102 together. In these examples, the coupling flap 144 is the adhering flap 110. The adhering flap 110 can have any suitable size and/or shape configured to be placed in a flush, face-to-face relationship with a surface (e.g., interior or exterior surface) of the first side wall 108a of the base 102 (e.g., formed by the first side panel 208a of the blank 200) and adhered to the surface of the first side wall 108a. For example, any suitable type of adhesive may be used to couple a surface of the adhering flap 110 to the surface of the first side wall 108a.

FIGS. 11-13 illustrate examples of the blank 200 for forming the base 102 and FIG. 14 illustrates and example of the cover 104 that utilize a mechanically coupled coupling assembly 148 to couple the cover 104 and the base 102 together. In these examples, the coupling flap 144 is the locking flap 116. The locking flap 116 can have any suitable size and/or shape (e.g., geometry) configured to be received by and mate with the locking receiver 114 of the first side wall 108a and engage the first side wall 108a.

Referring now to FIGS. 4, 5 and 11-13, in one or more examples, the blank 200 includes the locking receiver 114 formed in one of the side panels 208 (e.g., the first side panel 208a). In one or more examples, the locking receiver 114 includes at least one base-locking aperture 164 (e.g., as shown in the example of the base 102 shown in FIGS. 4 and 5). In the illustrated examples, the blank 200 and the base 102 formed from the blank 200 include two base-locking apertures 164 that are spaced apart from each other. In one or more examples, the base-locking aperture 164 is formed through the central portion of the first side panel 208a.

Referring to FIGS. 4 and 5, in one or more examples, the locking receiver 114 of the base 102 includes or is formed by at least one base-locking aperture 164, which is formed through the first side wall 108a, and at least one base-locking tab 166, which is coupled to or otherwise extends from the first side wall 108a about the base-locking aperture 164. The base-locking tab 166 is configured to be hingedly moved (e.g., folded) relative to the first side wall 108a into a noncoplanar relationship with the first side wall 108a. Movement of the base-locking tab 166 relative to the first side wall 108a creates the base-locking aperture 164. In the illustrated examples, the base 102 includes two base-locking apertures 164 and base-locking tabs 166, which are generally aligned with and spaced apart from each other.

Referring generally to FIGS. 4 and 5 and particularly to FIGS. 11-13, in one or more examples, the base-locking aperture 164 and the base-locking tab 166 are formed by a cut line 222, which is formed (e.g., stamped, cut, etched, die cut, etc.) through the first side panel 208a. The cut line 222 defines a perimeter shape of portion of the base-locking aperture 164 and the base-locking tab 166 and essentially separates a portion of the base-locking tab 166 from the first side panel 208a. In one or more examples, the cut line 222 is contoured or has a nonlinear shape, such as having a generally semicircular shape, semi-ovular shape, triangular shape, arrowhead shape, paddle shape or the like. In the illustrated examples, the blank 200 includes two cut lines 222, which are generally aligned with and spaced apart from each other.

Referring now to FIGS. 4, 5 and 14, in one or more examples, the locking flap 116 of the cover 104 includes at least one cover-locking tab 168. The cover-locking tab 168 is configured to be hingedly moved (e.g., folded) relative to the locking flap 116 into a noncoplanar relationship with the locking flap 116. In the illustrated examples, the cover 104 includes two cover-locking tabs 168, which are generally aligned with and spaced apart from each other.

In one or more examples, the cover-locking tab 168 is formed by a cut line 170. which is formed (e.g., stamped, cut, etched, die cut, etc.) through the locking flap 116. The cut line 170 defines a perimeter shape of portion of the cover-locking tab 168 and essentially separates a portion of the cover-locking tab 168 from the locking flap 116. In one or more examples, the cut line 170 is contoured or has a nonlinear shape, such as having a generally semicircular shape, semi-ovular shape, triangular shape, arrowhead shape, paddle shape, or the like. In the illustrated examples, the cover 104 includes two cut lines 170, which are generally aligned with and spaced apart from each other.

Generally, the number of base-locking apertures 164 and base-locking tabs 166 of the base 102 and the number of cover-locking tabs 168 of the cover 104 are the same. The base-locking aperture 164 is configured (e.g., has a size, shape, geometry suitable) to receive at least a portion of the cover-locking tab 168. For examples, during mechanical coupling of the cover 104 to the base 102, the cover-locking tab 168 is aligned with the base-locking tab 166. The cover-locking tab 168 and the base-locking tab 166 are folded into a noncoplanar relationship with the locking flap 116 and the first side wall 108a, respectively, such that at least a portion the cover-locking tab 168 is received by the base-locking aperture 164 and extends through the base-locking aperture 164.

Referring now to FIGS. 1, 9 and 11-13, in one or more examples, the blank 200 includes a first end flap 214a and a second end flap 214b. The first end flap 214a is hingedly coupled to or extends from the third side panel 208c along fold line 210m. The second end flap 214b is hingedly coupled to or extends from the fourth side panel 208d along fold line 210n. When the container 100 is formed from the blank 200, the first end flap 214a is folded into a noncoplanar relationship with the third side panel 208c, such that the first end flap 214a forms an upper end flap of the third side wall 108c of the base 102 (e.g., as shown in FIG. 1). When the container 100 is formed from the blank 200, the second end flap 214b is folded into a noncoplanar relationship with the fourth side panel 208d, such that the second end flap 214b forms an upper end flap of the fourth side wall 108d of the base 102 (e.g., as shown in FIG. 1).

In one or more examples, the first end flap 214a is folded inwardly (e.g., toward the interior volume of the base 102) and is oriented at an oblique angle relative to the third side wall 108c. Similarly, the second end flap 214b is folded inwardly (e.g., toward the interior volume of the base 102) and is oriented at an oblique angle relative to the fourth side wall 108d. When the cover 104 is coupled to the base 102 and is in the closed configuration, the first end flap 214a and the second end flap 214b support a portion of the cover 104. For example, the first end flap 214a is situated on an interior of the cover 104 and is aligned with and engages the third side wall 128c of the cover 104. The second end flap 214b is situated on an interior of the cover 104 and is aligned with and engages the fourth side wall 128d of the cover 104. The first end flap 214a and the second end flap 214b also fill any gaps formed between an upper end of the base 102 and a lower end of the cover 104.

Referring now to FIGS. 8, 9, 11-13, 15, 17, 18, 20 and 22, in one or more examples, the blank 200 includes one or more features that form a first portion of the closure assembly 150 of the container 100. Referring to FIGS. 10, 14, 16, 19, 21 and 22, in one or more examples, the cover 104 similarly includes one or more features that form a second portion of the closure assembly 150, which is configured to mate with or otherwise engage the first portion of the closure assembly 150 when the base 102 is formed from the blank 200, the cover 104 is coupled to the base 102, and the cover 104 is in the closed configuration (e.g., as shown in FIGS. 1, 2 and 4). As an example, the blank 200 includes the latching receiver 118, which formed in at least one of the side panels 208 and cover 104 includes the latching flap 120. The latching receiver 118 is configured to receive or otherwise engage the latching flap 120 to hold the cover 104 in the closed configuration relative to the base 102 formed from the blank 200.

Referring to FIG. 8, in one or more examples, the latching receiver 118 is formed by the fifth side panel 208e and the sixth side panel 208f. For example, the fifth side panel 208e includes a first base-latching tab 224a and the sixth side panel 208f includes a second base-latching tab 224b. The first base-latching tab 224a extends or projects outwardly opposite the second side panel 208b. The second base-latching tab 224b extends or projects outwardly opposite the second side panel 208b. The first base-latching tab 224a and the second base-latching tab 224b may have any suitable size, shape and/or perimeter geometry.

In one or more examples, the first base-latching tab 224a is formed or defined by a geometry of an edge 220e of the fifth side panel 208e, such that a notch or other opening is formed between the first base-latching tab 224a and the fifth side panel 208e. When the base 102 is formed from the blank 200, the first base-latching tab 224a is located at an upper end of the fifth side wall 108e of the base 102. In one or more examples, the second base-latching tab 224b is formed or defined by a geometry of an edge 220f of the sixth side panel 208f, such that a notch or other opening is formed between the second base-latching tab 224b and the sixth side panel 208f. When the base 102 is formed from the blank 200, the second base-latching tab 224b is located at an upper end of the sixth side wall 108f of the base 102.

In one or more examples, the cover 104 includes a first cover-latching tab 172a and a second cover-latching tab 172b. In one or more examples, the first cover-latching tab 172a extends or projects inwardly from the latching flap 120. The second cover-latching tab 172b is opposite the first cover-latching tab 172a and extends or projects inwardly from the latching flap 120. In one or more examples, the first cover-latching tab 172a and the second cover-latching tab 172b are formed or defined by a geometry of the latching flap 120, such that a notch or other opening is formed between the first cover-latching tab 172a and the first side wall 128a of the cover 104 and an opposing notch or other opening is formed between the second cover-latching tab 172b and the first side wall 128a of the cover 104.

With the base 102 formed from the blank 200 and the cover 104 coupled to the base 102 and in the closed configuration, the first base-latching tab 224a and the first cover-latching tab 172a engage each and the second base-latching tab 224b and the second cover-latching tab 172b engage each to releasably connect (e.g., hold) the cover 104 in the closed configuration. For example, the first cover-latching tab 172a is situated under the first base-latching tab 224a and is at least partially received by the notch formed between the first base-latching tab 224a and the fifth side wall 108e such that the first base-latching tab 224a overlaps at least a portion of the first cover-latching tab 172a. Similarly, the second cover-latching tab 172b is situated under the second base-latching tab 224b and is at least partially received by the notch formed between the second base-latching tab 224b and the sixth side wall 108f such that the second base-latching tab 224b overlaps at least a portion of the second cover-latching tab 172b.

Referring now to FIGS. 9, 11, 12 and 13, in one or more examples, the latching receiver 118 is formed by the second side panel 208b. For example, the second side panel 208b includes the first base-latching tab 224a the second base-latching tab 224b. The first base-latching tab 224a extends or projects inwardly opposite the fifth side panel 208208e. The first base-latching tab 224a and the second base-latching tab 224b may have any suitable size, shape and/or perimeter geometry.

In one or more examples, the first base-latching tab 224a and the second base-latching tab 224b are formed or defined by a geometry of an edge 220b of the second side panel 208b, such that a notch or other opening is formed between the first base-latching tab 224a and the second side panel 208b and an opposing notch or other opening is formed between the second base-latching tab 224b and the second side panel 208b. When the base 102 is formed from the blank 200, the first base-latching tab 224a and the second base-latching tab 224b are located at an upper end of the second side wall 108b of the base 102.

Referring now to FIGS. 10 and 14, in one or more examples, the cover 104 includes the first cover-latching tab 172a and the second cover-latching tab 172b. In one or more examples, the first cover-latching tab 172a extends or projects outwardly from the latching flap 120. The second cover-latching tab 172b is opposite the first cover-latching tab 172a and extends or projects outwardly from the latching flap 120. In one or more examples, the first cover-latching tab 172a and the second cover-latching tab 172b are formed or defined by a geometry of the latching flap 120, such that a notch or other opening is formed between the first cover-latching tab 172a and the first side wall 128a of the cover 104 and an opposing notch or other opening is formed between the second cover-latching tab 172b and the first side wall 128a of the cover 104.

With the base 102 formed from the blank 200 and the cover 104 coupled to the base 102 and in the closed configuration, the first base-latching tab 224a and the first cover-latching tab 172a engage each and the second base-latching tab 224b and the second cover-latching tab 172b engage each to releasably connect (e.g., hold) the cover 104 in the closed configuration. For example, the first cover-latching tab 172a is situated under the first base-latching tab 224a and is at least partially received by the notch formed between the first base-latching tab 224a and the second side wall 108b such that the first base-latching tab 224a overlaps at least a portion of the first cover-latching tab 172a. Similarly, the second cover-latching tab 172b is situated under the second base-latching tab 224b and is at least partially received by the notch formed between the second base-latching tab 224b and the second side wall 108b such that the second base-latching tab 224b overlaps at least a portion of the second cover-latching tab 172b.

Referring to FIGS. 9 and 11, in one or more examples, in one or more examples, the latching receiver 118 is further formed by the fifth side panel 208e and the sixth side panel 208f. For example, the fifth side panel 208e includes a third base-latching tab 224c and the sixth side panel 208f includes a fourth base-latching tab 224d. The third base-latching tab 224c extends or projects outwardly opposite the second side panel 208b. The fourth base-latching tab 224d extends or projects outwardly opposite the second side panel 208b. The third base-latching tab 224c and the fourth base-latching tab 224d may have any suitable size, shape and/or perimeter geometry.

In one or more examples, the third base-latching tab 224c is formed or defined by a geometry of the edge 220e of the fifth side panel 208e, such that a notch or other opening is formed between the third base-latching tab 224c and the fifth side panel 208e. When the base 102 is formed from the blank 200, the third base-latching tab 224c is located at an upper end of the fifth side wall 108e of the base 102. In one or more examples, the fourth base-latching tab 224d is formed or defined by a geometry of the edge 220f of the sixth side panel 208f, such that a notch or other opening is formed between the fourth base-latching tab 224d and the sixth side panel 208f. When the base 102 is formed from the blank 200, the fourth base-latching tab 224d is located at an upper end of the sixth side wall 108f of the base 102.

In one or more examples, the first base-latching tab 224a and the third base-latching tab 224c extend in opposite directions and may be referred to as inner and outer base-latching tabs, respectively. Similarly, the second base-latching tab 224b and the fourth base-latching tab 224d extend in opposite directions and may be referred to as inner and outer base-latching tabs, respectively.

In one or more examples, the cover 104 includes a third cover-latching tab and a fourth cover-latching tab (not explicitly shown). In one or more examples, the third cover-latching tab extends or projects inwardly from the latching flap 120. The fourth cover-latching tab is opposite the first cover-latching tab and extends or projects inwardly from the latching flap 120. In one or more examples, the third cover-latching tab and the fourth cover-latching tab are formed or defined by a geometry of the latching flap 120, such that a notch or other opening is formed between the third cover-latching tab and the first side wall 128a of the cover 104 and an opposing notch or other opening is formed between the fourth cover-latching tab and the first side wall 128a of the cover 104.

In one or more examples, the first cover-latching tab 172a and the third cover-latching tab extend in opposite directions and may be referred to as inner and outer cover-latching tabs, respectively. Similarly, the second cover-latching tab 172b and the fourth cover-latching tab extend in opposite directions and may be referred to as inner and outer cover-latching tabs, respectively.

With the base 102 formed from the blank 200 and the cover 104 coupled to the base 102 and in the closed configuration, the third base-latching tab 224c and the third cover-latching tab engage each and the fourth base-latching tab 224d and the fourth cover-latching tab engage each to releasably connect (e.g., hold) the cover 104 in the closed configuration. For example, the third cover-latching tab is situated under the third base-latching tab 224c and is at least partially received by the notch formed between the third base-latching tab 224c and the fifth side wall 108e such that the third base-latching tab 224c overlaps at least a portion of the third cover-latching tab. Similarly, the fourth cover-latching tab is situated under the fourth base-latching tab 224d and is at least partially received by the notch formed between the fourth base-latching tab 224d and the sixth side wall 108f such that the fourth base-latching tab 224d overlaps at least a portion of the fourth cover-latching tab.

Referring now to FIGS. 15, 17, 18 and 20, in one or more examples, the latching receiver 118 is formed by the second side panel 208b. For example, the blank 200 includes a base-latching flap 216 that is hingedly coupled to or that extends from the second side panel 208b along fold line 2100, which is approximately parallel to fold line 210b. The blank 200 includes a cut line 228 situated along a portion of fold line 2100. The cut line 228 is configured to form or define a base-latching aperture 226 in the second side wall 108b of the base 102, along fold line 2100, when the base-latching flap 216 is folded into a noncoplanar relationship with the second side panel 208b to form the base 102 from the blank 200. In one or more examples, the base-latching aperture 226 takes the form of a slot, elongate opening or the like.

Referring now to FIGS. 16, 19 and 21, in one or more examples, the cover 104 includes a cover-latching tab 172. In one or more examples, the cover 104 includes a cut line 180 situated along a portion of line of weakness 130b formed between the second side wall 128b of the cover 104 and the latching flap 120. The cut line 180 is configured to form or define the cover-latching tab 172 that extends or projects outwardly along line of weakness 130b, when the latching flap 120 is folded into a noncoplanar relationship with the second side wall 128b of the cover 104.

With the base 102 formed from the blank 200 and the cover 104 coupled to the base 102 and in the closed configuration, the base-latching aperture 226 is configured to receive at least a portion of the cover-latching tab 172. The base-latching aperture 226 and the cover-latching tab 172 may have any one of various configurations that enable the base-latching aperture 226 and the cover-latching tab 172 to mate with or otherwise engage each other such that the cover-latching tab 172 is retained in the base-latching aperture 226 to releasably connect the cover 104 to the base 102 in the closed configuration.

Referring to FIGS. 17 and 18, in one or more examples, the blank 200 includes more than one cut line 228 (e.g., two cut lines 228) situated along a portion of fold line 2100. The cut lines 228 is configured to form or define more than one base-latching aperture 226 (e.g., two base-latching apertures 226) in the second side wall 108b of the base 102, along fold line 2100, when the base-latching flap 216 is folded into a noncoplanar relationship with the second side panel 208b to form the base 102 from the blank 200. Similarly, in one or more examples, the cover 104 includes a first retaining tab 174a and a second retaining tab 174b opposite the first retaining tab 174a. In one or more examples, the cover 104 includes more than one cover-latching tab 172 (e.g., two cover-latching tabs 172). Each one of the base-latching apertures 226 is configured to receive at least a portion of a corresponding one of the cover-latching tabs 172.

Referring now to FIG. 15, in one or more examples, the blank 200 includes the first retaining aperture 160a formed through the third side panel 208c, which forms the first retaining aperture 160a in the third side wall 108c of the base 102 formed from the blank 200. The blank 200 also includes the second retaining aperture 160b formed through the fourth side panel 208d, which forms the second retaining aperture 160b in the fourth side wall 108d of the base 102 formed from the blank 200. The first retaining aperture 160a and the second retaining aperture 160b may have any suitable configuration (e.g., size, shape, geometry). For example, first retaining aperture 160a and the second retaining aperture 160b may take the form of a slot, elongate opening or the like formed (e.g., cut) through the third side panel 208c and the fourth side panel 28d, respectively.

Referring now to FIG. 16, in one or more examples, the cover 104 includes a first retaining tab 174a and a second retaining tab 174b opposite the first retaining tab 174a. In one or more examples, the cover 104 includes a cut line 176a situated along a portion of line of weakness 130c formed between the third side wall 128c of the cover 104 and a first retaining flap 178a. The cut line 176a is configured to form or define the first retaining tab 174a that extends or projects outwardly along line of weakness 130c, when the first retaining flap 178a is folded into a noncoplanar relationship with the third side wall 128c of the cover 104. In one or more examples, the cover 104 includes a cut line 176b situated along a portion of line of weakness 130d formed between the fourth side wall 128d of the cover 104 and a second retaining flap 178b. The cut line 176b is configured to form or define the second retaining tab 174b that extends or projects outwardly along line of weakness 130d, when the second retaining flap 178b is folded into a noncoplanar relationship with the fourth side wall 128d of the cover 104.

With the base 102 formed from the blank 200 and the cover 104 coupled to the base 102 and in the closed configuration, the first retaining aperture 160a is configured to receive at least a portion of the first retaining tab 174a and the second retaining aperture 160b is configured to receive at least a portion of the second retaining tab 174b. The first retaining aperture 160a, the second retaining aperture 160b, the first retaining tab 174a and the second retaining tab 174b may have any one of various configurations that enable a mating interlocking engagement with each other such that the cover 104 is releasably connected to the base 102 in the closed configuration.

Referring now to FIGS. 17, 18 and 22, in one or more examples, each one of the third side panel 208c and the fourth side panel 208d includes a first portion 218a and the second portion 218b, such that each one of the third side wall 108c and the fourth side wall 108d of the base 102 formed from the blank 200 includes two wall panels (e.g., a two-layered structure). For example, the first portion 218a of the third side panel 208c is hingedly connected to the bottom panel 206 along fold line 210c. The second portion 218b of the third side panel 208c is hingedly connected to or extends from the first portion 218a along fold line 210p. Similarly, the first portion 218a of the fourth side panel 208d is hingedly connected to the bottom panel 206 along fold line 210d. The second portion 218b of the fourth side panel 208d is hingedly connected to or extends from the first portion 218a along fold line 210q.

When the base 102 is formed from the blank 200, the second portion 218b of the third side panel 208c is folded relative to the first portion 218a such that the second portion 218b is aligned with (e.g., is at least approximately parallel to and in a face-to-face relationship with) the first portion 218a such that the third side wall 108c is a two-layer wall. Similarly, the second portion 218b of the fourth side panel 208d is folded relative to the first portion 218a such that the second portion 218b is aligned with (e.g., is at least approximately parallel to and in a face-to-face relationship with) the first portion 218a such that the fourth side wall 108d is a two-layer wall.

Referring to FIG. 17, in one or more examples, the second portion 218b of the third side panel 208c is mechanically coupled to the bottom panel 206 via an interlocking engagement between a panel-locking tab situated along an edge of the second portion 218b and a panel-locking aperture situated along fold line 210c. Similarly, the second portion 218b of the fourth side panel 208d is mechanically coupled to the bottom panel 206 via an interlocking engagement between a panel-locking tab situated along an edge of the second portion 218b and a panel-locking aperture situated along fold line 210d.

Referring to FIGS. 18 and 22, in one or more examples, the second portion 218b and the first portion 218a are coupled together. For example, facing surfaces of the second portion 218b and the first portion 218a may be adhesively coupled to each other using any suitable type of adhesive.

Referring again to FIGS. 17, 18 and 22, in one or more examples, the blank 200 includes a first aperture 182a formed through the third side panel 208c. In one or more examples, the first aperture 182a is situated along fold line 210p, such that, for example, the first aperture 182a is bisected by fold line 210p and a first portion of the first aperture 182a is formed in the first portion 218a and a second portion of the first aperture 182a is formed in the second portion 218b. Similarly, the blank 200 includes a second aperture 182b formed through the fourth side panel 208d. In one or more examples, the second aperture 182b is situated along fold line 210q, such that, for example, the second aperture 182b is bisected by fold line 210q and a first portion of the second aperture 182b is formed in the first portion 218a and a second portion of the second aperture 182b is formed in the second portion 218b.

When the base 102 is formed from the blank 200, the first aperture 182a forms or defines a first recess 152a situated along an upper edge of the third side wall 108c (e.g., as shown in FIG. 6). Similarly, the second aperture 182b forms or defines a second recess 152b situated along an upper edge of the fourth side wall 108d (e.g., as shown in FIG. 6).

Referring now to FIGS. 19 and 22, in one or more examples, the cover 104 includes the first protrusion 154a and the second protrusion 154b that is opposite the first protrusion 154a. The first protrusion 154a and the second protrusion 154b may be formed by any suitable fabrication technique. In examples in which the cover 104 is made of the plastic material, the first protrusion 154a and the second protrusion 154b may be molded in the body of the cover 104.

With the base 102 formed from the blank 200 and the cover 104 coupled to the base 102 and in the closed configuration, the first recess 152a receives at least a portion of the first protrusion 154a and the second recess 152b receives at least a portion of the second protrusion 154b. The first recess 152a, the second recess 152b, the first protrusion 154a and the second protrusion 154b may have any one of various configurations that enable a mating interlocking engagement with each other such that the cover 104 is releasably connected to the base 102 in the closed configuration.

Referring to FIG. 22, in one or more examples, the second side panel 208b includes a first portion 218a and a second portion 218b such that the second side wall 108b of the base 102 formed from the blank 200 includes two wall panels (e.g., a two-layered structure). For example, the first portion 218a of the second side panel 208b is hingedly connected to the bottom panel 206 along fold line 210b. The second portion 218b of the second side panel 208b is hingedly connected to or extends from the first portion 218a along fold line 210r.

When the base 102 is formed from the blank 200, the second portion 218b of the second side panel 208b is folded relative to the first portion 218a such that the second portion 218b is aligned with (e.g., is at least approximately parallel to and in a face-to-face relationship with) the first portion 218a such that the second side wall 108b is a two-layer wall. In one or more examples, the second portion 218b of the second side panel 208b is mechanically coupled to the bottom panel 206. In one or more examples, the second portion 218b and the first portion 218a of the second side panel 208b are coupled together (e.g., adhesively coupled to each other).

In one or more examples, the blank 200 includes a third aperture 182c formed through the second side panel 208b. In one or more examples, the third aperture 182c is situated along fold line 210r, such that, for example, the third aperture 182c is bisected by fold line 210r and a first portion of the third aperture 182c is formed in the first portion 218a and a second portion of the third aperture 182c is formed in the second portion 218b.

When the base 102 is formed from the blank 200, the third aperture 182c forms or defines a third recess 152c situated along an upper edge of the second side wall 108b (e.g., as shown in FIG. 6).

Referring now to FIG. 22, in one or more examples, the cover 104 includes a third protrusion 154c. In one or more examples, the first protrusion 154a, the second protrusion 154b and the third protrusion 154c project outward from a body of the cover 104. For example, the first protrusion 154a projects from the third side wall 128c of the cover 104, the second protrusion 154b projects from the fourth side wall 128d of the cover 104, and the third protrusion 154c projects from the second side wall 128b of the cover 104.

With the base 102 formed from the blank 200 and the cover 104 coupled to the base 102 and in the closed configuration, the third recess 152c receives at least a portion of the third protrusion 154c. The third recess 152c and the third protrusion 154c may have any one of various configurations that enable a mating interlocking engagement with each other such that the cover 104 is releasably connected to the base 102 in the closed configuration.

Referring now to FIG. 20, in one or more examples, each one of the third side panel 208c and the fourth side panel 208d includes a first portion 218a, a second portion 218b, and a third portion 218c, such that each one of the third side wall 108c and the fourth side wall 108d of the base 102 formed from the blank 200 includes two wall panels (e.g., a two-layered structure) and a bridge or spine that extends between the two wall panels along an upper end thereof.

For example, the first portion 218a of the third side panel 208c is hingedly connected to the bottom panel 206 along fold line 210c. The second portion 218b of the third side panel 208c is hingedly connected to or extends from the first portion 218a along fold line 210p. The third portion 218c of the third side panel 208c is hingedly connected to or extends from the second portion 218b along fold line 210s. Similarly, the first portion 218a of the fourth side panel 208d is hingedly connected to the bottom panel 206 along fold line 210d. The second portion 218b of the fourth side panel 208d is hingedly connected to or extends from the first portion 218a along fold line 210q. The third portion 218c of the fourth side panel 208d is hingedly connected to or extends from the second portion 218b along fold line 210t.

When the base 102 is formed from the blank 200, the second portion 218b of the third side panel 208c is folded relative to the first portion 218a and the third portion 218c is folded relative to the second portion 218b, such that the third portion 218c is aligned with (e.g., is at least approximately parallel to and in a face-to-face relationship with) the first portion 218a and the second portion 218b forms a first tongue 156a that extends along an upper portion of the third side wall 108c (e.g., as shown in FIG. 7). Similarly, the second portion 218b of the fourth side panel 208d is folded relative to the first portion 218a and the third portion 218c is folded relative to the second portion 218b, such that the second portion 218b is aligned with (e.g., is at least approximately parallel to and in a face-to-face relationship with) the first portion 218a and the second portion 218b forms a second tongue 156b that extends along an upper portion of the third side wall 108c (e.g., as shown in FIG. 7).

Referring now to FIG. 21, in one or more examples, the cover 104 includes a first groove 158a and a second groove 158b that is opposite the first groove 158a. The first groove 158a and the second groove 158b may be formed by any suitable fabrication technique. In examples in which the cover 104 is made of the plastic material, the first groove 158a and the second groove 158b may be molded in the body of the cover 104.

With the base 102 formed from the blank 200 and the cover 104 coupled to the base 102 and in the closed configuration, at least a portion of the first tongue 156a is inserted in (e.g., received by) the first groove 158a and at least a portion of the second tongue 156b is inserted in (e.g., received by) the second groove 158b. The first tongue 156a, the second tongue 156b, the first groove 158a and the second groove 157b may have any one of various configurations that enable a mating interlocking engagement with each other such that the cover 104 is releasably connected to the base 102 in the closed configuration.

By way of examples, the present disclosure is also directed to a method for forming the container 100. In one or more examples, the method includes a step of manipulating the blank 200 such that the bottom panel 206 of the blank forms the bottom wall 106 of the base 102 of the container and the side panels 208 of the blank 200 form the side walls 108 of the base 102 of the container 100. The method also includes a step of coupling the cover 104 to the first side wall 108a of the base 102 such that the cover 104 is hingedly movable relative to the first side wall 108a between the open configuration and the closed configuration. The cover 104 is releasably connected to at least the second side wall 108b of the base 102 in the closed configuration.

In one or more examples, the step of coupling the cover 104 to the first side wall 108a of the base 102 is performed using any one of the examples of the coupling assembly 148. As an example, the step of coupling the cover 104 to the first side wall 108a of the base 102 includes a step of adhesively coupling the first side wall 108a and the adhering flap 110 of the cover 104 together. As another example, the step of coupling the cover 104 to the first side wall 108a of the base 102 includes a step of mechanically coupling the locking receiver 114 of the first side wall 108a and locking flap 116 of the cover 104 together.

In one or more examples, the base 102 and the cover 104 are configured to be releasably connected to each other in the closed configuration using any one of the examples or combination of examples of the closure assembly 150.

By way of examples, the present disclosure is also directed to a method for packaging product in the container 100. In one or more examples, the method includes a step of forming the base 102 of the container 100, for example, from the blank 200. The method also includes a step of coupling the cover 104 to the first side wall 108a of the base 102. The method further includes a step of loading product in the internal volume formed by the base 102. The method additionally includes a step of hingedly moving the cover 104 relative to the first side wall 108a from the open configuration to the closed configuration. The method also includes a step of releasably connecting the cover 104 to at least the second side wall 108b of the base 102 in the closed configuration.

In one or more examples, the blank 200 and/or the base 102 (e.g., formed from the blank 200) is formed from a sheet of suitable substrate. It is to be understood that, as used herein, the term “suitable substrate” includes all manner of foldable sheet material such as paperboard, corrugated board, cardboard, plastic, combinations thereof, and the like. It should be recognized that one or other numbers of blanks may be employed, where suitable, for example, to provide the structure for the container 100.

In one or more examples, the cellulosic material includes paperboard. In one or more examples, the cellulosic material includes corrugated board or cardboard. In other examples, the container 100 and/or the blank 200 (e.g., used to form the container 100) is formed from a paperboard or corrugated board substrate. The substrate may be, for example, a solid bleached sulfate (SBS) substrate, an uncoated natural kraft (UNC) substrate, or a coated natural kraft (CNK) substrate. The substrate may be formed from virgin fibers, recycled fibers, or combinations thereof.

In one or more examples, the structure of the base 102 of the container 100 is formed from the sheet material, which may be made of or coated with materials to increase its strength. It should be noted that tear resistant materials, moisture or water resistant materials and the like may be provided by more than one layer, to help improve the tear-resistance and/or liquid resistance of the base 102 of the container 100. Typically, one surface of the sheet material may have different characteristics to the other surface. For example, a portion of the surface of the sheet material that faces outwardly from a finished base 102 may be particularly smooth and may have a coating such as a clay coating or other surface treatment to provide good printability. A portion of the surface of the sheet material that faces inwardly may, on the other hand, be provided with a coating, a layer, a treatment or be otherwise prepared to provide properties such as one or more of tear-resistance, good glue-ability, heat sealability, food contact, or other desired functional properties.

In one or more examples, use of the cellulosic material to form the base 102 of the container 100 provides sufficient strength to hold, ship and display various types of product. Additionally, the cellulosic material is also easily and economically recyclable. Further, the use of the cellulosic material enables the base 102 (e.g., the blanks 200 used to form the base 102) to be quickly and easily made, as well as quickly and easily modified to accommodate different styles (e.g., size, shape and configuration). Moreover, cutting and folding machinery for forming cellulosic blanks and cellulosic cartons from blanks are well known.

As used herein, the terms “hinged connection” and “fold line” refer to all manner of lines that define hinge features of a blank, facilitate folding portions of the blank with respect to one another, or otherwise indicate optimal panel folding locations for the blank. Any reference to “hinged connection” should not be construed as necessarily referring to a single fold line only; indeed, a hinged connection can be formed from two or more fold lines, wherein each of the two or more fold lines may be either straight/linear or curved/curvilinear in shape. When linear fold lines form a hinged connection, they may be disposed parallel with each other or be slightly angled with respect to each other. When curvilinear fold lines form a hinged connection, they may intersect each other to define a shaped panel within the area surrounded by the curvilinear fold lines. A typical example of such a hinged connection may include a pair of arched or arcuate fold lines intersecting at two points such that they define an elliptical panel therebetween. A hinged connection may be formed from one or more linear fold lines and one or more curvilinear fold lines. A typical example of such a hinged connection may include a combination of a linear fold line and an arched or arcuate fold line which intersect at two points such that they define a half moon-shaped panel therebetween.

As used herein, the term “fold line” may refer to one of the following: a scored line, an embossed line, a debossed line, a line of perforations, a line of short slits, a line of half-cuts, a single half-cut, an interrupted cutline, a line of aligned slits, a line of scores and any combination of the aforesaid options.

It should be understood that hinged connections and fold lines can each include elements that are formed in the substrate of the blank including perforations, a line of perforations, a line of short slits, a line of half-cuts, a single half-cut, a cutline, an interrupted cutline, slits, scores, embossed lines, debossed lines, any combination thereof, and the like. The elements can be dimensioned and arranged to provide the desired functionality. For example, a line of perforations can be dimensioned or designed with degrees of weakness to define a fold line and/or a severance line. The line of perforations can be designed to facilitate folding and resist breaking, to facilitate folding and facilitate breaking with more effort, or to facilitate breaking with little effort.

The preceding detailed description refers to the accompanying drawings, which illustrate specific examples of the disclosed container 100, base 102 for the container 100, blank 200 for forming the base 102, and methods described by the present disclosure. It will be understood that the disclosed examples are merely exemplary embodiments of the way in which certain aspects of the of the disclosed container 100, base 102 for the container 100, blank 200 for forming the base 102, and methods can be implemented and do not represent an exhaustive list of all of the ways the of the disclosed container 100, base 102 for the container 100, blank 200 for forming the base 102, and methods may be embodied. Other examples having different structures and operations do not depart from the scope of the present disclosure.

Well-known components, materials or methods are not necessarily described in detail in order to avoid obscuring the present disclosure. Any specific structural and functional details disclosed herein are not meant to be interpreted as limiting, but merely as a basis for the claims and as a representative basis for teaching one skilled in the art to variously employ the invention.

Like reference numerals may refer to the same feature, element, or component in the different drawings. The figures are not necessarily to scale and some features may be exaggerated or minimized to show details of particular components.

Throughout the present disclosure, any one of a plurality of items may be referred to individually as the item and a plurality of items may be referred to collectively as the items. Moreover, as used herein, a feature, element, component, or step preceded with the word “a” or “an” should be understood as not excluding a plurality of features, elements, components or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

It is to be understood that not necessarily all objects or advantages may be achieved in accordance with any particular example described herein. Thus, for example, those skilled in the art will recognize that certain examples may be configured to operate in a manner that achieves or optimizes one advantage or group of advantages as taught herein without necessarily achieving other objects or advantages as may be taught or suggested herein.

Conditional language such as, among others, “can” or “may,” unless specifically stated otherwise, are otherwise understood within the context as used in general to convey that certain examples include, while other examples do not include, certain features, elements and/or steps. Thus, such conditional language is not generally intended to imply that features, elements and/or steps are in any way required for one or more examples or that one or more examples necessarily include logic for deciding, with or without user input or prompting, whether these features, elements and/or steps are included or are to be performed in any particular example.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

It should be appreciated that, when used to modify a structure, an element, an item, a component or a feature described herein, the terms “front,” “back,” “rear,” “bottom,” “top,” “left,” “right,” “side,” “end,” “upper,” “lower,” “inner,” “outer,” “interior,” “exterior,” as well as similar terms or other forms of such terms, are relative and refer to an example of a spatial relationship between structures, elements, items, components or features. As such, examples of the blanks and the cartons, described herein and illustrated in the figures, are not intended to be limited by the specific relative terms used to describe any structure, element, item, component or feature thereof.

Those skilled in the art will appreciate that not all elements described and illustrated in FIGS. 1-23 need be included in every example and not all elements described herein are necessarily depicted in each illustrative example. FIGS. 1-23, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1-23, referred to above, need be included in every example and not all elements, features, and/or components described herein are necessarily depicted in each illustrative example. Accordingly, some of the elements, features, and/or components described and illustrated in FIGS. 1-23 may be combined in various ways without the need to include other features described and illustrated in FIGS. 1-23, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1-23, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1-23, and such elements, features, and/or components may not be discussed in detail herein with reference to each of FIGS. 1-23. Similarly, all elements, features, and/or components may not be labeled in each of FIGS. 1-23, but reference numerals associated therewith may be utilized herein for consistency.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but do not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the container 100, base 102 for the container 100, blank 200 for forming the base 102, and methods have been shown and described, modifications may occur to those skilled in the art upon reading the specification. The present application includes such modifications and is limited only by the scope of the claims.

What is claimed is:

1. A base for a container, the base comprising:
a bottom wall; and
side walls extending from the bottom wall;
wherein:
a first side wall of the side walls of the base is configured to be coupled to a cover that is hingedly movable relative to the first side wall between an open configuration and a closed configuration; and
at least a second side wall of the side walls of the base is configured to be releasably connected to the cover in the closed configuration.

2. The base of claim 1, wherein the base is made of a cellulosic material.

3. The base of claim 1, wherein the first side wall of the base is configured to be adhesively coupled to the cover.

4. The base of claim 1, wherein the first side wall of the base is configured to be mechanically coupled to the cover.

5. The base of claim 4, wherein:
the first side wall comprises a locking receiver formed therein; and
the locking receiver is configured to receive a portion of a latching flap of the cover to mechanically couple the first side wall and the cover together.

6. The base of claim 1, wherein:
the second side wall is opposite the first side wall;
the second side wall comprises a latching receiver; and
the latching receiver is configured to receive a portion of a latching flap of the cover to releasably connect the second side wall and the cover together in the closed configuration.

7. The base of claim 1, wherein:
a third side wall of the side walls of the base comprises a first recess;
a fourth side wall of the side walls of the base is opposite the third side wall and comprises a second recess; and
the first recess is configured to receive a first protrusion of the cover and the second recess is configured to receive a second protrusion of the cover in the closed configuration.

8. The base of claim 1, wherein:
at least one of the side walls of the base comprises a tongue located along an upper edge thereof; and
the tongue is configured to be received by a groove formed in the cover in the closed configuration.

9. The base of claim 1, wherein an upper portion of at least one of the side walls is configured to support the cover in the closed configuration.

10. The base of claim 9, wherein the base is configured to receive a portion of the cover between at least two of the side walls of the base in the closed configuration.

11. The base of claim 9, wherein a portion of at least one of the side walls is configured to be situated in the cover in the closed configuration.

12. The base of claim 1, wherein the base is formed from a blank of sheet material.

13. A blank for forming the base of claim 1.

14. A blank for forming a base of a container, the blank comprising:
a bottom panel; and
side panels connected to the bottom panel along fold lines,
wherein:
a first side panel of the side panels is configured for coupling a cover that is hingedly movable relative to the first side panel; and
a second side panel of the side panels is configured for releasable connecting the cover to the second side panel.

15. The blank of claim 14, wherein the blank is made of a sheet of cellulosic material.

16. The blank of claim 14, wherein the first side panel is configured to be adhesively coupled to the cover.

17. The blank of claim 14, wherein the first side panel is configured to be mechanically coupled to the cover.

18. The blank of claim 17, wherein:
the first side panel comprises a locking receiver formed therein; and
the locking receiver is configured to receive a portion of a locking flap of the cover to mechanically couple the first side panel and the cover together.

19. The blank of claim 14, wherein:
the second side panel is opposite the first side panel;
the second side panel comprises a latching receiver; and
when the container is formed from the blank, the latching receiver is configured to receive a portion of a latching flap of the cover to releasably connect the second side panel and the cover together in a closed configuration.

20. The blank of claim 14, further comprising:
a first aperture formed in a third side panel of the side panels; and
a second aperture formed in a fourth side panel of the side panels,
wherein, when the container is formed from the blank:
the first aperture forms a first recess that is configured to receive a first protrusion of the cover when the cover is in a closed configuration; and
the second aperture forms a second recess that is configured to receive a second protrusion of the cover when the cover is in the closed configuration.

21. The blank of claim 14, wherein, when the container is formed from the blank:
at least one of the side panels forms a tongue located along an upper edge thereof; and
the tongue is configured to be received by a groove formed in the cover when the cover is in a closed configuration.

22. A container comprising:
a base comprising a bottom wall and side walls; and
a cover coupled to and hingedly movable relative to a first side wall of the side walls between an open configuration and a closed configuration,
wherein the cover is releasably connected to at least a second side wall of the side walls in the closed configuration.

23. The container of claim 22, wherein:
the base is made of a first material; and
the cover is made of a second material.

24. The container of claim 23, wherein the first material and the second material are different.

25. The container of claim 24, wherein:
the first material is a cellulosic material; and
the second material is a plastic material.

26. The container of claim 22, wherein the cover is transparent.

27. The container of claim 22, wherein the cover is adhesively coupled (adhered) to the first side wall.

28. The container of claim 26, wherein the cover comprises an adhering flap that is adhesively coupled to a portion of a surface of the first side wall.

29. The container of claim 22, wherein the cover is mechanically coupled to the first side wall.

30. The container of claim 29, wherein:
the first side wall comprises a locking receiver formed therein;
the cover comprising a latching flap; and
a portion of the latching flap is received by the locking receiver to mechanically couple the cover to the first side wall.

31. The container of claim 22, wherein:
the second side wall is opposite the first side wall;
the second side wall comprises a latching receiver;
the cover comprises a latching flap; and
a portion of the latching flap is received by the latching receiver to releasably connect the cover to the second side wall in the closed configuration.

32. The container of claim 22, wherein:
a third side wall of the side walls comprises a first recess;
a fourth side wall of the side walls is opposite the third side wall and comprises a second recess;
the cover comprises a first protrusion and a second protrusion that is opposite the first protrusion; and
the first protrusion is received by the first recess and the second protrusion is received by the second recess in the closed configuration.

33. The container of claim 22, wherein:
at least one of the side walls comprises a tongue located along an upper edge thereof;
the cover comprises a groove formed therein; and
the tongue is received by the groove in the closed configuration.

34. The container of claim 22, wherein the cover is supported by an upper portion of at least one of the side walls in the closed configuration.

35. The container of claim 33, wherein a portion of the cover is situated in the base and between at least two of the side walls of the base in the closed configuration.

36. The container of claim 33, wherein a portion of at least one of the side walls is situated in the cover in the closed configuration.

37. The container of claim 22, wherein the base is formed from a blank of sheet material.

38. A blank for forming the base of the container of claim 22.

39. A method for forming a container, the method comprising steps of:
manipulating a blank such that a bottom panel of the blank forms a bottom wall of a base of the container and side panels of the blank form side walls of the base of the container; and
coupling a cover to a first side wall of the side walls of the base such that the cover is hingedly movable relative to the first side wall between an open configuration and a closed configuration,
wherein the cover is releasably connected to at least a second side wall of the side walls of the base in the closed configuration.

40. The method of claim 39, wherein:
the blank is made of a first material; and
the cover is made of a second material.

41. The method of claim 40, wherein the first material and the second material are different.

42. The method of claim 41, wherein:
the first material is a cellulosic material; and
the second material is a plastic material.

43. The method of claim 40, wherein the cover is transparent.

44. The method of claim 39, wherein the step of coupling the cover to the first side wall of the base comprises adhesively coupling the first side wall and the cover together.

45. The method of claim 39, wherein the step of coupling the cover to the first side wall of the base comprises mechanically coupling the first side wall and the cover together.

46. A method for packaging product in a container, the method comprises steps of:
forming a base of the container;
coupling a cover to a first side wall of the base;
loading product in an internal volume formed by the base;
hingedly moving the cover relative to the first side wall from an open configuration to a closed configuration; and
releasably connecting the cover to at least a second side wall of the base in the closed configuration.

47. The method of claim 46, wherein:
the base is made of a first material; and
the cover is made of a second material.

48. The method of claim 47, wherein the first material and the second material are different.

49. The method of claim 48, wherein:
the first material is a cellulosic material; and
the second material is a plastic material.

50. The method of claim 47, wherein the cover is transparent.

51. The method of claim 46, wherein the step of coupling the cover to the first side wall of the base comprises adhesively coupling the first side wall and the cover together.

52. The method of claim 46, wherein the step of coupling the cover to the first side wall of the base comprises mechanically coupling the first side wall and the cover together.

53. The method of claim 46, wherein the step of forming the base of the container comprises erecting the base from a blank.
